(19) United States
(12) Patent Application Publication
(10) Pub. No.: US 2026/0197822 A1
(43) Pub. Date: Jul. 9, 2026

(54) RESOURCE POOLS FOR CONTROL INFORMATION AND DATA FOR SELF-SCHEDULED UPLINK TRANSMISSIONS

(71) Applicant: QUALCOMM Incorporated, San Diego, CA (US)

(72) Inventors: Raviteja PATCHAVA, San Diego, CA (US); Jing SUN, San Diego, CA (US); Yan ZHOU, San Diego, CA (US); Jing JIANG, San Diego, CA (US)

(21) Appl. No.: 19/013,461

(22) Filed: Jan. 8, 2025

(51) Int. Cl. H04W 72/1268

(52) U.S. Cl. CPC H04W 72/1268

(57) ABSTRACT

Methods, systems, and devices for wireless communications are described. A network entity may allocate two resource pools for user equipments (UEs) to perform self-scheduled uplink transmission to the network entity. For example, the network entity may allocate a first uplink resource pool for uplink control information (UCI) and a second uplink resource pool for the UE self-scheduled data transmissions (e.g., physical uplink shared channel (PUSCH) communications that carry data). A UE may transmit a UCI message via a resource of the first uplink resource pool that reserves or schedules a resource of the second uplink resource pool for a PUSCH communication. Accordingly, the network entity may perform blind-decoding on the resources of the first resource pool but may refrain from performing blind decoding on the resources of the second resource pool.

### FIELD OF TECHNOLOGY

The following relates to wireless communications, including resource pools for control information and data for self-scheduled uplink transmissions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving control signaling that indicates a first uplink resource pool and a second uplink resource pool, where the first uplink resource pool is associated with uplink control information (UCI) for UE self-scheduled shared channel communications, and where the second uplink resource pool is associated with the UE self-scheduled shared channel communications, transmitting an UCI message via a first uplink resource of the first uplink resource pool, where the UCI message includes scheduling information for an uplink shared channel communication in a second uplink resource of the second uplink resource pool, and transmitting the uplink shared channel communication via the second uplink resource in accordance with the scheduling information.

A UE for wireless communications is described. The UE may include at least one processor and at least one memory coupled with the at least one processor, with instructions stored in the at least one memory. The instructions may be executable by the at least one processor, individually or in any combination, to cause the UE to receive control signaling that indicates a first uplink resource pool and a second uplink resource pool, where the first uplink resource pool is associated with UCI for UE self-scheduled shared channel communications, and where the second uplink resource pool is associated with the UE self-scheduled shared channel communications, transmit an UCI message via a first uplink resource of the first uplink resource pool, where the UCI message includes scheduling information for an uplink shared channel communication in a second uplink resource of the second uplink resource pool, and transmit the uplink shared channel communication via the second uplink resource in accordance with the scheduling information.

Another UE for wireless communications is described. The UE may include means for receiving control signaling that indicates a first uplink resource pool and a second uplink resource pool, where the first uplink resource pool is associated with UCI for UE self-scheduled shared channel communications, and where the second uplink resource pool is associated with the UE self-scheduled shared channel communications, means for transmitting an UCI message via a first uplink resource of the first uplink resource pool, where the UCI message includes scheduling information for an uplink shared channel communication in a second uplink resource of the second uplink resource pool, and means for transmitting the uplink shared channel communication via the second uplink resource in accordance with the scheduling information.

A non-transitory computer-readable medium storing code for wireless communications is described. The code may include instructions executable by one or more processors to receive control signaling that indicates a first uplink resource pool and a second uplink resource pool, where the first uplink resource pool is associated with UCI for UE self-scheduled shared channel communications, and where the second uplink resource pool is associated with the UE self-scheduled shared channel communications, transmit an UCI message via a first uplink resource of the first uplink resource pool, where the UCI message includes scheduling information for an uplink shared channel communication in a second uplink resource of the second uplink resource pool, and transmit the uplink shared channel communication via the second uplink resource in accordance with the scheduling information.

In some examples of the method, UEs, and non-transitory computer-readable medium described herein, receiving the control signaling may include operations, features, means, or instructions for receiving an indication of a one-to-one mapping between first uplink resources of the first uplink resource pool and second uplink resources of the second uplink resource pool, where the first uplink resource may be one-to-one mapped to the second uplink resource pool in accordance with the one-to-one mapping, and where the scheduling information indicates the second uplink resource based on the one-to-one mapping.

In some examples of the method, UEs, and non-transitory computer-readable medium described herein, randomly selecting the first uplink resource from the first uplink resource pool and selecting the second uplink resource from the second uplink resource pool based on the first uplink resource.

In some examples of the method, UEs, and non-transitory computer-readable medium described herein, receiving the control signaling may include operations, features, means, or instructions for receiving an indication of a mapping between each second uplink resource of the second uplink resource pool and a set of multiple first uplink resources of the first uplink resource pool, where the first uplink resource may be mapped to the second uplink resource pool in accordance with the mapping, and where the scheduling information indicates the second uplink resource based on the mapping.

In some examples of the method, UEs, and non-transitory computer-readable medium described herein, the scheduling information includes a field indicative of the second uplink resource.

In some examples of the method, UEs, and non-transitory computer-readable medium described herein, receiving the control signaling may include operations, features, means, or instructions for receiving an indication of a mapping between first uplink resources of the first uplink resource pool and respective sets of second uplink resources of the second uplink resource pool, where the second uplink resource pool may be within a respective set of second uplink resources mapped to the first uplink resource in accordance with the mapping.

In some examples of the method, UEs, and non-transitory computer-readable medium described herein, randomly selecting the first uplink resource from the first uplink resource pool and randomly selecting the second uplink resource from the second uplink resource pool.

Some examples of the method, UEs, and non-transitory computer-readable medium described herein may further include operations, features, means, or instructions for receiving a downlink control information (DCI) message with a cyclic redundancy check scrambled by an identifier associated with the UE, where the DCI message includes a feedback message for the uplink shared channel communication.

Some examples of the method, UEs, and non-transitory computer-readable medium described herein may further include operations, features, means, or instructions for receiving a group-common DCI message, where a payload of the group-common DCI message includes an identifier associated with the UE and a feedback message for the uplink shared channel communication.

Some examples of the method, UEs, and non-transitory computer-readable medium described herein may further include operations, features, means, or instructions for receiving a group-common DCI message, where a payload of the group-common DCI message includes a feedback bitmap associated with second uplink resources of the second uplink resource pool, where the control signaling indicates a mapping between the second uplink resource and respective one or more bits of the feedback bitmap.

Some examples of the method, UEs, and non-transitory computer-readable medium described herein may further include operations, features, means, or instructions for receiving, after transmission of the uplink shared channel communication, an uplink grant for a retransmission of the uplink shared channel communication and transmitting the retransmission of the uplink shared channel communication in accordance with the uplink grant.

Some examples of the method, UEs, and non-transitory computer-readable medium described herein may further include operations, features, means, or instructions for transmitting, based on an absence of a feedback message for the uplink shared channel communication within a time period after transmission of the uplink shared channel communication, a second UCI message via a third uplink resource of the first uplink resource pool, where the second UCI message includes second scheduling information for a retransmission of the uplink shared channel communication in a fourth uplink resource of the second uplink resource pool and transmitting the retransmission of the uplink shared channel communication via the fourth uplink resource in accordance with the second scheduling information.

In some examples of the method, UEs, and non-transitory computer-readable medium described herein, the UCI message indicates a modulation and coding scheme associated with the uplink shared channel communication, a payload size associated with the uplink shared channel communication, an identifier associated with the UE, or any combination thereof.

A method for wireless communications by a network entity is described. The method may include outputting control signaling that indicates a first uplink resource pool and a second uplink resource pool, where the first uplink resource pool is associated with UCI for UE self-scheduled shared channel communications, and where the second uplink resource pool is associated with the UE self-scheduled shared channel communications, obtaining, in association with a UE, an UCI message via a first uplink resource of the first uplink resource pool, where the UCI message includes scheduling information for an uplink shared channel communication in a second uplink resource of the second uplink resource pool, and obtaining, in association with the UE, the uplink shared channel communication via the second uplink resource in accordance with the scheduling information.

A network entity for wireless communications is described. The network entity may include at least one processor and at least one memory coupled with the at least one processor, with instructions stored in the at least one memory. The instructions may be executable by the at least one processor, individually or in any combination, to cause the network entity to output control signaling that indicates a first uplink resource pool and a second uplink resource pool, where the first uplink resource pool is associated with UCI for UE self-scheduled shared channel communications, and where the second uplink resource pool is associated with the UE self-scheduled shared channel communications, obtain, in association with a UE, an UCI message via a first uplink resource of the first uplink resource pool, where the UCI message includes scheduling information for an uplink shared channel communication in a second uplink resource of the second uplink resource pool, and obtain, in association with the UE, the uplink shared channel communication via the second uplink resource in accordance with the scheduling information.

Another network entity for wireless communications is described. The network entity may include means for outputting control signaling that indicates a first uplink resource pool and a second uplink resource pool, where the first uplink resource pool is associated with UCI for UE self-scheduled shared channel communications, and where the second uplink resource pool is associated with the UE self-scheduled shared channel communications, means for obtaining, in association with a UE, an UCI message via a first uplink resource of the first uplink resource pool, where the UCI message includes scheduling information for an uplink shared channel communication in a second uplink resource of the second uplink resource pool, and means for obtaining, in association with the UE, the uplink shared channel communication via the second uplink resource in accordance with the scheduling information.

A non-transitory computer-readable medium storing code for wireless communications is described. The code may include instructions executable by one or more processors to output control signaling that indicates a first uplink resource pool and a second uplink resource pool, where the first uplink resource pool is associated with UCI for UE self-scheduled shared channel communications, and where the second uplink resource pool is associated with the UE self-scheduled shared channel communications, obtain, in association with a UE, an UCI message via a first uplink resource of the first uplink resource pool, where the UCI message includes scheduling information for an uplink shared channel communication in a second uplink resource of the second uplink resource pool, and obtain, in association with the UE, the uplink shared channel communication via the second uplink resource in accordance with the scheduling information.

In some examples of the method, network entities, and non-transitory computer-readable medium described herein, outputting the control signaling may include operations, features, means, or instructions for outputting an indication of a one-to-one mapping between first uplink resources of the first uplink resource pool and second uplink resources of the second uplink resource pool, where the first uplink resource may be one-to-one mapped to the second uplink resource pool in accordance with the one-to-one mapping, and where the scheduling information indicates the second uplink resource based on the one-to-one mapping.

In some examples of the method, network entities, and non-transitory computer-readable medium described herein, outputting the control signaling may include operations, features, means, or instructions for outputting an indication of a mapping between each second uplink resource of the second uplink resource pool and a set of multiple first uplink resources of the first uplink resource pool, where the first uplink resource may be mapped to the second uplink resource pool in accordance with the mapping, and where the scheduling information indicates the second uplink resource based on the mapping.

In some examples of the method, network entities, and non-transitory computer-readable medium described herein, the scheduling information includes a field indicative of the second uplink resource.

In some examples of the method, network entities, and non-transitory computer-readable medium described herein, outputting the control signaling may include operations, features, means, or instructions for outputting an indication of a mapping between first uplink resources of the first uplink resource pool and respective sets of second uplink resources of the second uplink resource pool, where the second uplink resource pool may be within a respective set of second uplink resources mapped to the first uplink resource in accordance with the mapping.

Some examples of the method, network entities, and non-transitory computer-readable medium described herein may further include operations, features, means, or instructions for outputting a DCI message with a cyclic redundancy check scrambled by an identifier associated with the UE, where the DCI message includes a feedback message for the uplink shared channel communication.

Some examples of the method, network entities, and non-transitory computer-readable medium described herein may further include operations, features, means, or instructions for outputting a group-common DCI message, where a payload of the group-common DCI message includes an identifier associated with the UE and a feedback message for the uplink shared channel communication.

Some examples of the method, network entities, and non-transitory computer-readable medium described herein may further include operations, features, means, or instructions for outputting a group-common DCI message, where a payload of the group-common DCI message includes a feedback bitmap associated with second uplink resources of the second uplink resource pool, where the control signaling indicates a mapping between the second uplink resource and respective one or more bits of the feedback bitmap.

Some examples of the method, network entities, and non-transitory computer-readable medium described herein may further include operations, features, means, or instructions for outputting, after obtention of the uplink shared channel communication, an uplink grant for a retransmission of the uplink shared channel communication and obtaining the retransmission of the uplink shared channel communication in accordance with the uplink grant.

Some examples of the method, network entities, and non-transitory computer-readable medium described herein may further include operations, features, means, or instructions for outputting the uplink grant may be based on successfully decoding the UCI message and failing to successfully decode the uplink shared channel communication.

Some examples of the method, network entities, and non-transitory computer-readable medium described herein may further include operations, features, means, or instructions for obtaining, in association with an absence of a feedback message for the uplink shared channel communication within a time period after transmission of the uplink shared channel communication, a second UCI message via a third uplink resource of the first uplink resource pool, where the second UCI message includes second scheduling information for a retransmission of the uplink shared channel communication in a fourth uplink resource of the second uplink resource pool and obtaining the retransmission of the uplink shared channel communication via the fourth uplink resource in accordance with the second scheduling information.

In some examples of the method, network entities, and non-transitory computer-readable medium described herein, the UCI message indicates a modulation and coding scheme associated with the uplink shared channel communication, a payload size associated with the uplink shared channel communication, an identifier associated with the UE, or any combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports resource pools for control information and data for self-scheduled uplink transmissions in accordance with one or more aspects of the present disclosure.

FIG. 2 shows an example of a wireless communications system that supports resource pools for control information and data for self-scheduled uplink transmissions in accordance with one or more aspects of the present disclosure.

FIG. 3 shows an example of a resource pool mapping diagram that supports resource pools for control information and data for self-scheduled uplink transmissions in accordance with one or more aspects of the present disclosure.

FIG. 4 shows an example of a resource pool mapping diagram that supports resource pools for control information and data for self-scheduled uplink transmissions in accordance with one or more aspects of the present disclosure.

FIG. 5 shows an example of a process flow that supports resource pools for control information and data for self-scheduled uplink transmissions in accordance with one or more aspects of the present disclosure.

FIGS. 6 and 7 show block diagrams of devices that support resource pools for control information and data for self-scheduled uplink transmissions in accordance with one or more aspects of the present disclosure.

FIG. 8 shows a block diagram of a communications manager that supports resource pools for control information and data for self-scheduled uplink transmissions in accordance with one or more aspects of the present disclosure.

FIG. 9 shows a diagram of a system including a device that supports resource pools for control information and data for self-scheduled uplink transmissions in accordance with one or more aspects of the present disclosure.

FIGS. 10 and 11 show block diagrams of devices that support resource pools for control information and data for self-scheduled uplink transmissions in accordance with one or more aspects of the present disclosure.

FIG. 12 shows a block diagram of a communications manager that supports resource pools for control information and data for self-scheduled uplink transmissions in accordance with one or more aspects of the present disclosure.

FIG. 13 shows a diagram of a system including a device that supports resource pools for control information and data for self-scheduled uplink transmissions in accordance with one or more aspects of the present disclosure.

FIGS. 14 and 15 show flowcharts illustrating methods that support resource pools for control information and data for self-scheduled uplink transmissions in accordance with one or more aspects of the present disclosure.

### DETAILED DESCRIPTION

In some wireless communications systems, various wireless communication devices may support self-scheduled uplink transmissions. For example, a user equipment (UE) may perform a self-scheduled uplink transmission to a network entity. A self-scheduled uplink transmission may be an uplink transmission performed in the absence of scheduling signaling from a network entity, such as in the absence of downlink control information (DCI) scheduling the uplink transmission. A self-scheduled uplink transmission may be equivalently referred to or understood as a UE self-scheduled transmission. In some systems, a network entity may allocate (e.g., configure) an uplink resource pool associated with UE self-scheduled transmissions (such that, for example, resources of the uplink resource pool are exclusively used for UE self-scheduled transmissions). In such systems, a UE may perform a self-scheduled transmission via an uplink resource from the uplink resource pool. Such operations may incur a substantial processing cost at the network side (due to blind channel estimation and decoding as well as associated buffering).

In some aspects, to receive UE self-scheduled transmissions and reduce the amount of resources on which the network entity performs blind-decoding, a network entity may allocate two uplink resource pools. The network entity may allocate a first uplink resource pool for uplink control information (UCI) and a second uplink resource pool for the UE self-scheduled data transmissions (e.g., physical uplink shared channel (PUSCH) communications that carry data). A UE may transmit a UCI message via a resource of the first uplink resource pool that reserves or schedules a resource of the second uplink resource pool for a PUSCH communication. Accordingly, the network entity may perform blind-decoding on the resources of the first resource pool but may refrain from performing blind decoding on the resources of the second resource pool. The amount of resources to blind decode may accordingly be reduced, as the resources for UCI may be smaller than the resources for PUSCH (e.g., may include fewer resource elements (REs)).

Aspects of the disclosure are initially described in the context of wireless communications systems. Aspects of the disclosure are further illustrated by and described herein with reference to wireless communication systems, resource pool mapping diagrams, process flows, apparatus diagrams, system diagrams, and flowcharts that relate to resource pools for control information and data for self-scheduled uplink transmissions.

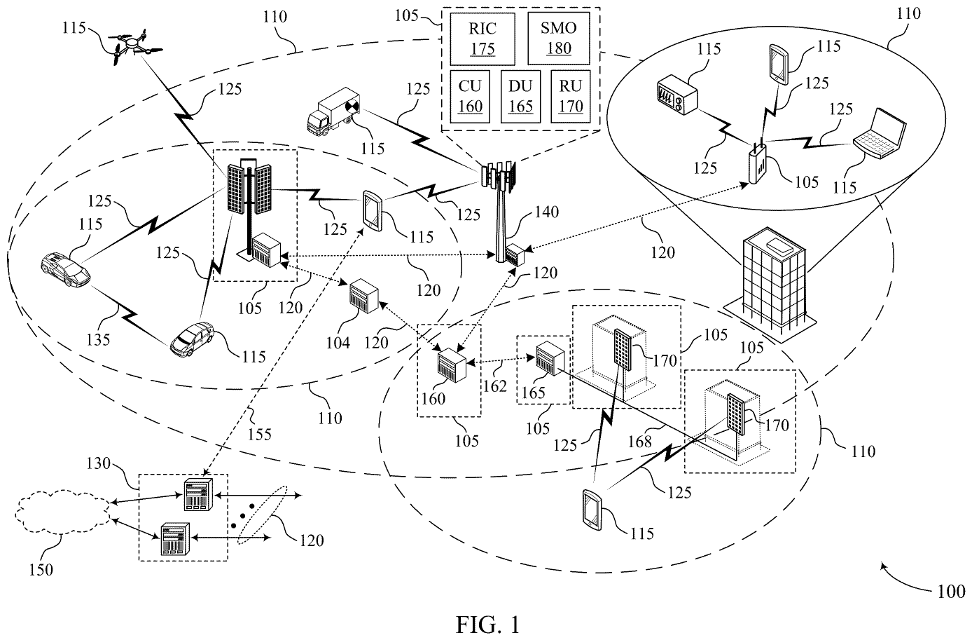

FIG. 1 shows an example of a wireless communications system 100 that supports resource pools for control information and data for self-scheduled uplink transmissions in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L 3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L 1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support resource pools for control information and data for self-scheduled uplink transmissions as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some aspects, the wireless communications system 100 may support UE self-scheduled transmissions to reduce downlink control signaling by the network entity 105. For example, per UE 115 uplink scheduling from the network entity 105 may demand the network entity 105 to transmit a large quantity of control signals to schedule uplink transmissions for UEs 115, especially in scenarios where the network entity 105 communicates with a large quantity of UEs 115 (e.g., with IoT devices). UE self-scheduled transmissions may be considered as an augmentation of configured grants (CGs). For example, with UE self-scheduled transmissions, the network entity 105 may not allow full self-scheduling flexibility for the UE 115, as the network entity 105 may provide a resource pool from which a UE 115 may select uplink resources. Use of UE self-scheduled transmissions may reduce downlink control overhead and accordingly may save power at the network entity 105.

The network entity 105 may configure an uplink resource pool for multiple UEs 115, and accordingly, multiple UEs 115 may collide on the same resource (e.g., if the multiple UEs 115 select the same resource). Additionally, self-scheduled uplink transmissions from multiple UEs may cause interference with each other which may degrade performance (e.g., may degrade the ability of the network entity 105 to successfully decode the self-scheduled uplink transmissions). CRC may be used to uniquely identify an uplink self-scheduled transmission as uniquely belonging to a given UE 115 (as each UE 115 may scramble the CRC of a self-scheduled uplink transmission with a unique identifier (ID) for the UE 115 known to the network entity 105). In uplink, a UE 115 may be provided with multiple overlapping CG-PUSCHs and may select one of the multiple overlapping CG-PUSCH on which to transmit. Configuration of multiple overlapping CG-PUSCHs, however, may lead to over-provisioning of resources, and the flexibility of the overlapping CG-PUSCHs may be limited (e.g., the UE 115 may be restricted to a small set of resources that may not be updated or adjusted frequently).

In some examples, the network entity 105 may configure an uplink resource pool for UE self-scheduled transmissions for multiple UEs 115. For example, the network entity may configure the resource pool and allocate each resource of the resource pool to multiple UEs, similarly to the PUSCH of a 2-step random access channel (RACH) procedure (e.g., except a physical RACH (PRACH) may not be used to access the resources and multiple configurations (possibly overlapping) may be supported to support payload and modulation and coding scheme (MCS) adaptation). In some examples, resource pools may be constructed for CG-PUSCH and the network entity 105 may control the probability of whether a particular UE 115 may access one of the resources in the resource pool. In some examples, the resource pool size may be adjustable. In some examples, the network entity 105 may configure heterogenous resource pools, and the network entity 105 may support dimensions of flexibility in selection of the resources.

To transmit a UE self-scheduled uplink transmission using a resource of a configured resource pool, a UE 115 may select a resource to use and may transmit using the selected resource (e.g., with an MCS and payload size selected based on channel conditions and the size of the resource). The network entity 105 may perform blind channel estimation and decoding for each resource in the resource pool in order to receive self-scheduled uplink transmissions over the resources of the resource pool. Accordingly, for a large resource pool, the processing load on the network entity 105 for decoding UE self-scheduled uplink transmissions may be extensive. In some examples, the processing load on the network entity 105 may be reduced via transmission by the UEs 115 of a self-decodable UCI in each resource of the resource pool in which the UEs 115 transmit. Each UCI may contain a CRC for independent decoding of the UCI from the corresponding PUSCH transmission. The network entity 105 may first decode the UCI using blind decoding, and the UCI may include information regarding the MCS, UE ID, and/or unit ID, and the network entity 105 may proceed with decoding the payload (e.g., the PUSCH) of the UE self-scheduled uplink transmission in the resource using the information conveyed in the UCI. Processing such UCIs in each of the resources of the resource pools may involve buffering the UCI portion of each resource in the resource pool, which may be processing and memory intensive at the network entity 105.

In some aspects, the wireless communication system may support standalone UCI indicators to reduce blind decoding at the network entity 105 associated with self-scheduled uplink transmissions. For example, to receive UE self-scheduled transmissions and reduce the amount of resources on which the network performs blind-decoding, a network entity 105 may allocate two uplink resource pools. The network entity 105 may allocate a first uplink resource pool for UCI and a second uplink resource pool for the UE self-scheduled data transmissions (e.g., PUSCH communications that carry data). A UE 115 may transmit a UCI message via a resource of the first uplink resource pool that reserves or schedules a resource of the second uplink resource pool for a PUSCH communication. Accordingly, the network entity 105 may perform blind-decoding on the resources of the first resource pool but may refrain from performing blind decoding on the resources of the second resource pool.

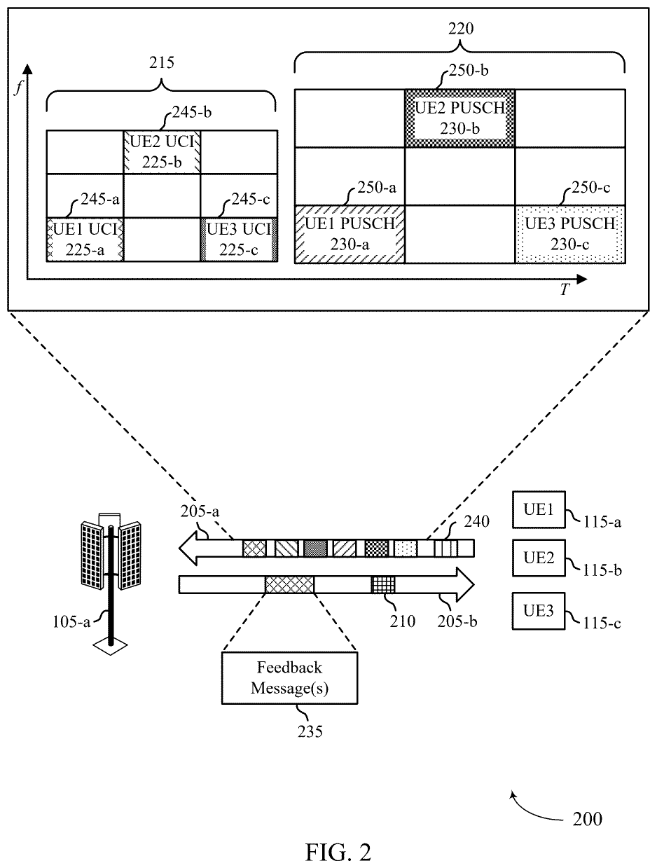

FIG. 2 shows an example of a wireless communications system 200 that supports resource pools for control information and data for self-scheduled uplink transmissions in accordance with one or more aspects of the present disclosure. The wireless communications system 200 may implement or may be implemented by aspects of the wireless communications system 100. For example, the wireless communications system 200 illustrates communication between a network entity 105-a, a UE 115-a (illustrated as a “UE1” in FIG. 2), a UE 115-b (illustrated as a “UE2” in FIG. 2), and a UE 115-c (illustrated as a “UE2” in FIG. 2) which may be examples of corresponding devices as illustrated and described herein, including by and with reference to FIG. 1.

As illustrated in the example of the wireless communications system 200, a UE 115 (e.g., the UE 115-a, the UE 115-b, and/or the UE 115c) may transmit uplink signaling via a communication link 205-a and the network entity 105-a may transmit downlink signaling via a communication link 205-b. Accordingly, the communication link 205-a may be an example of an uplink and the communication link 205-b may be an example of a downlink.

The network entity 105-a, UE 115-a, the UE 115-b, and/or the UE 115-c may support UE self-scheduled transmissions (e.g., self-scheduled uplink transmissions) to reduce an amount of downlink (e.g., scheduling) signaling from the network entity 105-a. For example, the network entity 105-a may transmit control signaling 210 that may indicate a first uplink resource pool 215 of resources 245 (e.g., time-frequency resources) and a second uplink resource pool 220 of resources 250 (e.g., time-frequency resources). The first uplink resource pool 215 may be associated with UCI 225, and the second uplink resource pool 220 may be associated with UE self-scheduled shared channel communications 230 (e.g., UE-self scheduled PUSCH communications).

For example, each UE 115 may select a resource 245 of the first uplink resource pool 215 to transmit a UCI 225 that includes scheduling information for a corresponding UE self-scheduled shared channel communication 230 in a resource 250 of the second resource pool. A UCI 225 may be transmitted using a PUSCH waveform. Scheduling information included in a UCI may include the UE ID, MCS, and/or payload size. The UCIs 225 may be transmitted earlier in time than the corresponding UE self-scheduled shared channel communications 230.

For example, the UE 115-a may transmit a UCI 225-a in the resource 245-a that includes scheduling information for the UE self-scheduled shared channel communication 230-a in the resource 250-a, the UE 115-b may transmit a UCI 225-b in the resource 245-b that includes scheduling information for the UE self-scheduled shared channel communication 230-b in the resource 250-b, and the UE 115-c may transmit a UCI 225-c in the resource 245-c that includes scheduling information for the UE self-scheduled shared channel communication 230-c in the resource 250-c.

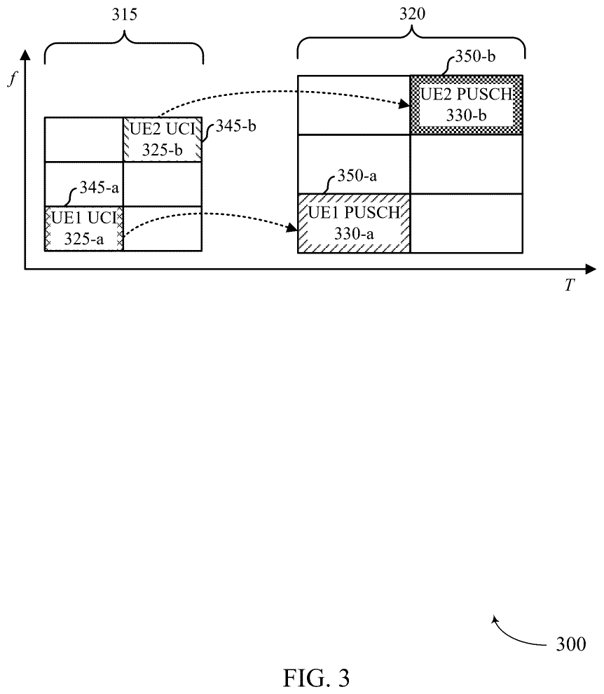

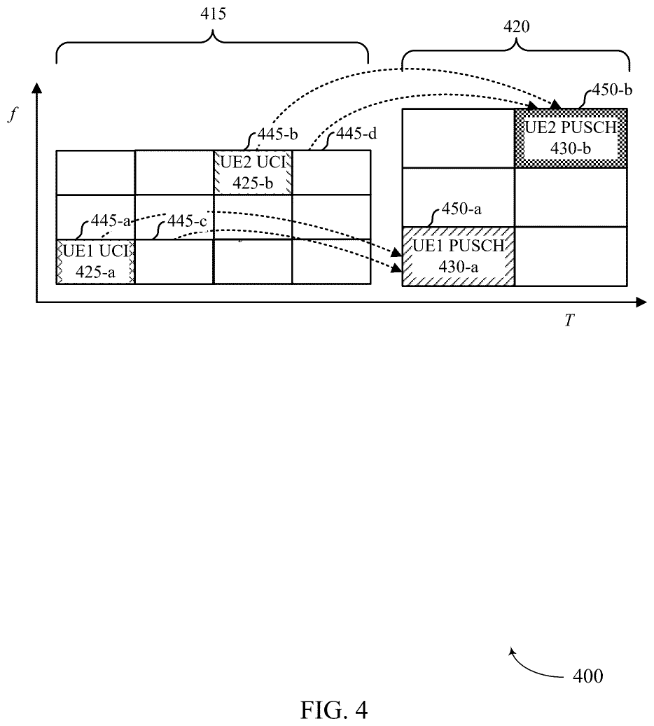

In some examples, each UCI 225 may explicitly indicate the resource 250 from the second uplink resource pool 220 for the corresponding UE self-scheduled shared channel communications 230. For example, each UCI 225 may include a field indicating the corresponding resource 250. In some examples, as described herein with reference to FIGS. 3 and 4, the UCIs 225 may implicitly indicate the corresponding resources 250 (e.g., based on a mapping between resources 245 of the first uplink resource pool 215 and the resources 250 of the second uplink resource pool 220). For example, the control signaling 210 may indicate the mapping(s) between resources 245 of the first uplink resource pool 215 and the resources 250 of the second resource pool.

The network entity 105-a may first decode the UCIs 225 received in the resources 245 of the first uplink resource pool 215. The network entity 105-a may accordingly determine the MCS, payload size, and/or the time/frequency resources of the UE self-scheduled shared channel communications 230 that will be transmitted in the resources 250 of the second uplink resource pool 220. In some examples, the network entity 105-a accordingly may refrain from performing blind decoding in the resources 250 of the second uplink resource pool 220. As the UCIs 225 may be transmitted prior to the UE self-scheduled shared channel communications 230, and as the resources 245 may be smaller than the resources 250 (e.g., may include fewer REs per resource) the quantity of data to be buffered by the network entity 105 may be reduced.

In some examples, the network entity 105-a may provide feedback message(s) 235 (e.g., HARQ feedback) for the UCI 225 and/or the UE self-scheduled shared channel communications 230.

In some examples, as described herein with reference to FIG. 3, each resource 245 of the first uplink resource pool 215 may be one-to-one mapped to a resource 250 of the second uplink resource pool 220. Such a mapping may be indicated, for example, in the control signaling 210. In some such examples, if the network entity 105-a successfully decodes a UCI 225 and the corresponding data (e.g., the corresponding UE self-scheduled shared channel communication 230), the network entity 105-a may transmit a UE-specific ACK to the UE 115 that transmitted the UCI 225 and the corresponding data. For example, if the network entity 105-a successfully receives the UCI 225-a and the UE self-scheduled shared channel communication 230-a, the network entity 105-a may transmit a feedback message 235 that includes an ACK via a DCI scrambled by a UE ID for the UE 115-a (e.g., the cell radio network temporary ID (C-RNTI) for the UE 115-a), which may be referred to as feedback Option 1A. In some examples, the feedback message 235 may be a group common DCI with the relevant UE IDs (e.g., C-RNTIs) in the payload (e.g., referred to as feedback Option 1B). For example, the feedback message 235 may be a group common DCI that includes UE IDs for the UE 115-a and the UE 115-b to ACK the UCI 225-a, the UE self-scheduled shared channel communication 230-a, the UCI 225-b, and the UE self-scheduled shared channel communication 230-b. In some examples, a DCI-type feedback message (e.g., a group common DCI) may include a hashed version of the UE ID(s) to reduce the payload of the DCI.

In some examples, where each resource 245 of the first uplink resource pool 215 is one-to-one mapped to a resource 250 of the second uplink resource pool 220, the feedback message 235 may be a group common DCI with a payload of ACK/NACK bits that correspond to each of the resources 250 (e.g., referred to as feedback Option 1C). For example, the payload of ACK/NACK bits may be a bitmap with each bit mapped (e.g., via the control signaling or based on a predefined mapping) to a resource 250. In such examples, each bit in the group common DCI may correspond to a single resource ID. For example, the group common DCI message may include a bit corresponding to the resource 250-a that indicates an ACK (e.g., to ACK the UE self-scheduled shared channel communication 230-a), a bit corresponding to the resource 250-b that indicates an ACK (e.g., to ACK the UE self-scheduled shared channel communication 230-b), and a bit corresponding to the resource 250-c that indicates an NACK (e.g., to NACK the UE self-scheduled shared channel communication 230-c, for example, if multiple UEs transmitted in the resource 250-c). A group common DCI with a payload of ACK/NACK bits that correspond to each of the resources 250 may result in packet loss in the case of collisions. For example, if two UEs 115 transmit in the same resource 245 and the same resource 250, and the network entity 105-a successfully decodes only one of the colliding UE self-scheduled shared channel communications 230, both UEs 115 may assume an ACK, and thus the UE 115 which transmitted the UE self-scheduled shared channel communication 230 that was not successfully decoded may not retransmit the UE self-scheduled shared channel communication 230. Such a packet loss may occur for the weaker signal-to-noise ratio (SNR) UE among the colliding UEs 115.

In some examples, where the first uplink resource pool 215 is one-to-one mapped to a resource 250-a of the second uplink resource pool 220, if the network entity 105-a successfully decodes a UCI 225 but not the corresponding UE self-scheduled shared channel communication 230, the network entity 105-a may transmit a NACK to the UE 115 using any of feedback Options 1A, 1B, or 1C as described herein. In some examples, where the first uplink resource pool 215 is one-to-one mapped to a resource 250-a of the second uplink resource pool 220, if the network entity 105-a successfully decodes a UCI 225 but not the corresponding UE self-scheduled shared channel communication 230, the network entity 105-a may send a retransmission grant using a DCI scrambled by the UE ID (the C-RNTI) (e.g., the feedback message 235 may be a DCI that provides a grant for a retransmission 240 of the UE self-scheduled shared channel communication 230).

In some examples, if the network entity 105-a does not successfully decode both a UCI 225 and the corresponding UE self-scheduled shared channel communication 230, the network entity 105-a may not transmit a feedback message 235 for the UCI 225 and the corresponding UE self-scheduled shared channel communication 230, the UE 115-a may identify the lack of the feedback message 235 as an implicit NACK, and the UE 115-a may perform a retransmission 240 of the UCI 225 and the corresponding UE self-scheduled shared channel communication 230 with a power ramp. The power ramp may be predefined or configured by the network entity 105-a (e.g., via the control signaling 210).

In some examples, as described herein with reference to FIG. 4, each resource 250 of the second uplink resource pool 220 may be mapped to multiple resources 245 of the first uplink resource pool 215 (e.g., the control signaling 210 may indicate a one-to-many mapping between the resources 250 of the second resource pool and the resources 245 of the first resource pool). In such examples, the network entity 105-a may provide feedback message(s) 235 using any of feedback Options 1A, 1B, or 1C as described herein.

In some examples, each UCI 225 may include an explicit indication of the resource 250 for the corresponding UE self-scheduled shared channel communication 230. For example, the UCI 225-a may include a field indicating selection of the resource 250-a, the UCI 225-b may include a field indicating selection of the resource 250-b, and the UCI 225-c may include a field indicating selection of the resource 250-c. In some examples, the explicit indication of the resource 250 for the corresponding UE self-scheduled shared channel communication 230 may indicate a set of resource units (e.g., as compared to full time domain resource allocation (TDRA) and frequency domain resource allocation (FDRA) fields). For example, each UE 115 may randomly select the resource 245 for the UCI 225 from the first uplink resource pool 215 and each UE 115 may randomly select the resource 250 for the UE self-scheduled shared channel communication 230 from the second uplink resource pool 220. In some examples, each resource 245 may be mapped (e.g., via the control signaling 210) to a subset of resources 250 of the second uplink resource pool 220. For example, each UE 115 may randomly select the resource 250 for the UE self-scheduled shared channel communication 230 from the subset of resources 250 mapped to the randomly selected resource 245. Explicit indication of the resource 250 in the UCI 225 may allow for more flexibility in the quantity of resources 245 and resources 250 configured in the first uplink resource pool 215 and the second uplink resource pool 220 as compared to mapping-based indication of the resource 250. In such examples where the UCI 225 explicitly indicate the resource 250, if the network entity 105-a successfully decodes a UCI 225, the network entity 105-a may proceed with decoding the UE self-scheduled shared channel communication 230 in the indicated resource 250.

In some examples, for resources 250 which no UCI indicated as being scheduled for a UE self-scheduled shared channel communication 230, the network entity 105-a may proceed with blind decoding or may skip blind decoding (e.g., up to network entity 105-a implementation). For example, as UCI collision may not correspond to a collision between UE self-scheduled shared channel communications 230 (e.g., as UCI resources and UE self-scheduled shared channel communication resources may be selected independently), the network entity 105-a may be able to successfully decode a UE self-scheduled shared channel communication 230 scheduled by a UCI 225 that was not successfully decoded due to a collision of the UCI 225. In some examples, as the network entity 105-a may be able to successfully decode a UE self-scheduled shared channel communication 230 scheduled by a UCI 225 that was not successfully decoded, the UE self-scheduled shared channel communications 230 may include an indication of the UE ID information. In such examples where each UCI 225 may include an explicit indication of the resource 250 for the corresponding UE self-scheduled shared channel communication 230, the network entity 105-a may provide feedback message(s) 235 using any of feedback Options 1A, 1B, or 1C as described herein.

FIG. 3 shows an example of a resource pool mapping diagram 300 that supports resource pools for control information and data for self-scheduled uplink transmissions in accordance with one or more aspects of the present disclosure. The resource pool mapping diagram 300 may implement or may be implemented by aspects of the wireless communications system 100 or the wireless communications system 200.

As described herein, a network entity 105 may configure a first uplink resource pool 315 of resources 345 (e.g., time-frequency resources) and a second uplink resource pool 320 of resources 350 (e.g., time-frequency resources). The first uplink resource pool 315 may be associated with UCI 325, and the second uplink resource pool 320 may be associated with UE self-scheduled shared channel communications 330 (e.g., self scheduled PUSCH communications). In some examples, each resource 345 of the first uplink resource pool 315 may be one-to-one mapped to a resource 350 of the second uplink resource pool 320. In some examples, such a mapping may be indicated in the control signaling 210 as described with reference to FIG. 2. In some examples, such a mapping may be fixed or standardized.

In examples where the resources 245 and one-to-one mapped to the resource 250, as shown in FIG. 3, the quantity of resources 345 of the first uplink resource pool 315 may be equal to the quantity of resources 350 of the second uplink resource pool 320 (e.g., though the quantity of REs in each resource 345 may be smaller than the quantity of REs in each resource 350).

In some examples, where each resource 345 of the first uplink resource pool 315 is one-to-one mapped to a resource 350 of the second uplink resource pool 320, each UE 115 may randomly select a resource 345 from the first resource pool for a UCI 325, and each UE 115 may transmit a corresponding UE self-scheduled shared channel communication 330 in the resource 350 mapped to the randomly selected resource 345 for the UCI 325. For example, the UE1 115 may randomly select the resource 345-a for the UCI 325-a and may transmit the UE self-scheduled shared channel communication 330-a in the resource 350-a mapped to the resource 345-a randomly selected and used to transmit the UCI 325-a. Similarly, the UE2 115 may randomly select the resource 345-b for the UCI 325-b and may transmit the UE self-scheduled shared channel communication 330-b in the resource 350-b mapped to the resource 345-b randomly selected and used to transmit the UCI 325-b. If a network entity 105 successfully decodes a UCI 325 in a given resource 345, the network entity 105 may proceed with decoding the UE self-scheduled shared channel communication 330 in the resource 350 mapped to the given resource 345 using the MCS and payload information included in the UCI 325.

FIG. 4 shows an example of a resource pool mapping diagram 400 that supports resource pools for control information and data for self-scheduled uplink transmissions in accordance with one or more aspects of the present disclosure. The resource pool mapping diagram 400 may implement or may be implemented by aspects of the wireless communications system 100 or the wireless communications system 200.

As described herein, a network entity 105 may configure a first uplink resource pool 415 of resources 445 (e.g., time-frequency resources) and a second uplink resource pool 420 of resources 450 (e.g., time-frequency resources). The first uplink resource pool 415 may be associated with UCI 425, and the second uplink resource pool 420 may be associated with UE self-scheduled shared channel communications 430 (e.g., UE-self scheduled PUSCH communications). In some examples, each resource 450 of the second uplink resource pool 420 may be mapped to multiple resources 445 of the first uplink resource pool 415 (e.g., there may be a many-to-one mapping between the resources 445 and the resources 450). In such cases, the quantity of resources 445 may be larger than the quantity of resource 450 (e.g., though the quantity of REs in each resource 445 may be smaller than the quantity of REs in each resource 450). In some examples, such a mapping may be indicated in the control signaling 210 as described with reference to FIG. 2. In some examples, such a mapping may be fixed or standardized. For example, the resource 445-a and the resource 445-c may be mapped to the resource 450-a, and the resource 445-b and the resource 445-d may be mapped to the resource 450-b.

In some examples, where the resources 445 of the first uplink resource pool 415 are many-to-one mapped to resources 450 of the second uplink resource pool 420 each UE 115 may randomly select a resource 445 from the first resource pool for a UCI 425, and each UE 115 may transmit a corresponding UE self-scheduled shared channel communication 430 in the resource 450 mapped to the randomly selected resource 445 for the UCI 425.

For example, the UE1 115 may randomly select the resource 445-a for the UCI 425-a and may transmit the UE self-scheduled shared channel communication 430-a in the resource 450-a mapped to the resource 445-a randomly selected and used to transmit the UCI 425-a. Similarly, the UE2 115 may randomly select the resource 445-b for the UCI 325-b and may transmit the UE self-scheduled shared channel communication 430-b in the resource 450-b mapped to the resource 445-b randomly selected and used to transmit the UCI 425-b.

If a network entity 105 successfully decodes a UCI 425 in a given resource 445, the network entity 105 may proceed with decoding the UE self-scheduled shared channel communication 430 in the resource 450 mapped to the given resource 445 using the MCS and payload information included in the UCI 425. Where the resources 445 of the first uplink resource pool 415 are many-to-one mapped to the resources 450 of the second uplink resource pool 420, the network entity 105 may have an increased probability of successfully decoding UCI 425 based on the increased quantity of resources 445 for UCI, which may enable the network entity 105 to detect a UE transmission of UCI and start retransmission (e.g., in the case UCI 425 is successfully decoded but the corresponding UE self-scheduled shared channel communication 430 is not successfully decoded).

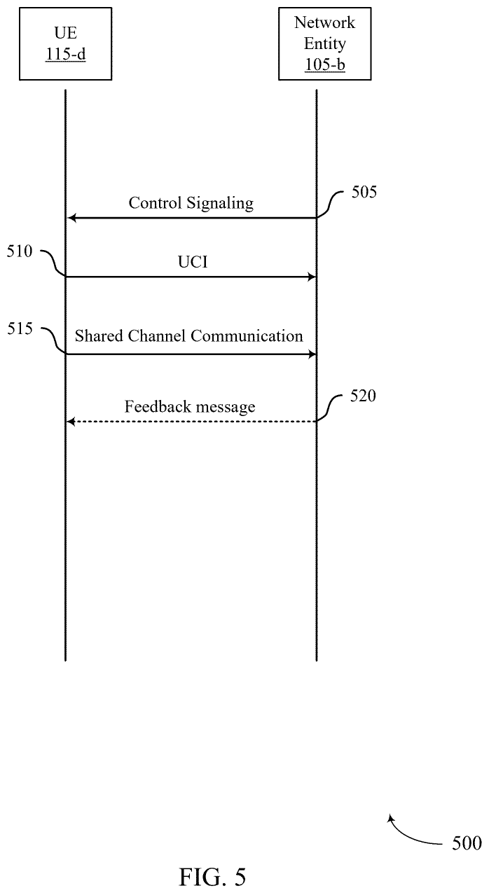

FIG. 5 shows an example of a process flow 500 that supports resource pools for control information and data for self-scheduled uplink transmissions in accordance with one or more aspects of the present disclosure. The process flow 500 may implement or may be implemented by aspects of the wireless communications system 100, the wireless communications system 200, the resource pool mapping diagram 300, or the resource pool mapping diagram 400. For example, the process flow 500 illustrates communication between a network entity 105-b and a UE 115-d, which may be examples of corresponding devices as illustrated and described herein, including by and with reference to FIG. 1-4.

Alternative examples of the following may be implemented. Some steps may be performed in a different order than described or may not be performed at all. In some implementations, steps may include additional features not mentioned below, or further steps may be added. Further, although example devices are shown performing the operations of the process flow 500, some aspects of some operations also may be performed by one or more other wireless communication devices without exceeding the scope of the present disclosure. For example, the network entity 105-a may perform some aspects of some operations across multiple components, which may be disaggregated or collocated.

At 505, the network entity 105-b may transmit, and the UE 115-d may receive, control signaling that indicates a first uplink resource pool and a second uplink resource pool. The first uplink resource pool (e.g., a first uplink resource pool 215 as described with reference to FIG. 2, a first uplink resource pool 315 as described with reference to FIG. 3, or a first uplink resource pool 415 as described with reference to FIG. 4) may be associated with UCI for UE self-scheduled shared channel communications. The second uplink resource pool (e.g., a second uplink resource pool 220 as described with reference to FIG. 2, a second uplink resource pool 320 as described with reference to FIG. 3, or a second uplink resource pool 420 as described with reference to FIG. 4) may be associated with the UE self-scheduled shared channel communications.

At 510, the UE 115-d may transmit, and the network entity 105-b may receive, an UCI message via a first uplink resource of the first uplink resource pool. The UCI message may include scheduling information for an uplink shared channel communication in a second uplink resource of the second uplink resource pool.

At 515, the UE 115-d may transmit, and the network entity 105-b may receive, the uplink shared channel communication via the second uplink resource in accordance with the scheduling information.

In some examples, network entity 105-b may transmit, and/or the UE 115-d may receive, an indication of a one-to-one mapping between first uplink resources of the first uplink resource pool and second uplink resources of the second uplink resource pool. In such examples, the first uplink resource may be one-to-one mapped to the second uplink resource pool in accordance with the one-to-one mapping, and the scheduling information may indicate the second uplink resource based on the one-to-one mapping.

In some examples, the UE 115-d may randomly select the first uplink resource from the first uplink resource pool. In such examples, the UE 115-d may select the second uplink resource from the second uplink resource pool based on the first uplink resource.

In some examples, network entity 105-b may transmit, and/or the UE 115-d may receive, an indication of a mapping between each second uplink resource of the second uplink resource pool and a set of multiple first uplink resources of the first uplink resource pool. In such examples, the first uplink resource may be mapped to the second uplink resource pool in accordance with the mapping, and the scheduling information may indicate the second uplink resource based on the mapping.

In some examples, the scheduling information may include a field indicative of the second uplink resource. In some such examples, network entity 105-b may transmit, and/or the UE 115-d may receive, an indication of a mapping between first uplink resources of the first uplink resource pool and respective sets of second uplink resources of the second uplink resource pool, and the second uplink resource pool may be within a respective set of second uplink resources mapped to the first uplink resource in accordance with the mapping. In some examples, the UE 115-d may randomly select the first uplink resource from the first uplink resource pool, and the UE 115-d may randomly select the second uplink resource from the second uplink resource pool.

In some examples, at 520, the network entity 105-b may transmit a feedback message for the UCI at 510 and/or the shared channel communication at 515. For example, the network entity 105-b may transmit, and the UE 115-d may receive, a DCI message with a CRC scrambled by an ID associated with the UE. In such examples, the DCI message may include a feedback message for the uplink shared channel communication. As another example, the network entity 105-b may transmit, and the UE 115-d may receive, a group-common DCI message. In such examples, a payload of the group-common DCI message may include an ID associated with the UE and a feedback message for the uplink shared channel communication. As another example, the network entity 105-b may transmit, and the UE 115-d may receive, a group-common DCI message. A payload of the group-common DCI message may include a feedback bitmap associated with second uplink resources of the second uplink resource pool (e.g., the feedback bitmap may be a set of ACK/NACK bits mapped to the second uplink resources). In such examples, the control signaling may indicate a mapping between the second uplink resource and respective one or more bits of the feedback bitmap.

In some examples, the network entity 105-b may transmit, and the UE 115-d may receive, after transmission of the uplink shared channel communication, an uplink grant for a retransmission of the uplink shared channel communication. For example, the feedback message at 520 may be the uplink grant for the retransmission. In such examples, the UE 115-d may transmit, and the network entity 105-b may receive, the retransmission of the uplink shared channel communication in accordance with the uplink grant.

In some examples, the UE 115-d may transmit, and the network entity 105-b may receive, based on an absence of a feedback message for the uplink shared channel communication within a time period after transmission of the uplink shared channel communication, a second UCI message via a third uplink resource of the first uplink resource pool. The second UCI message may include second scheduling information for a retransmission of the uplink shared channel communication in a fourth uplink resource of the second uplink resource pool. In such examples, the UE 115-d may transmit, and the network entity 105-b may receive, the retransmission of the uplink shared channel communication via the fourth uplink resource in accordance with the second scheduling information.

In some examples, the UCI message indicates a MCS associated with the uplink shared channel communication, a payload size associated with the uplink shared channel communication, an ID associated with the UE, or any combination thereof.

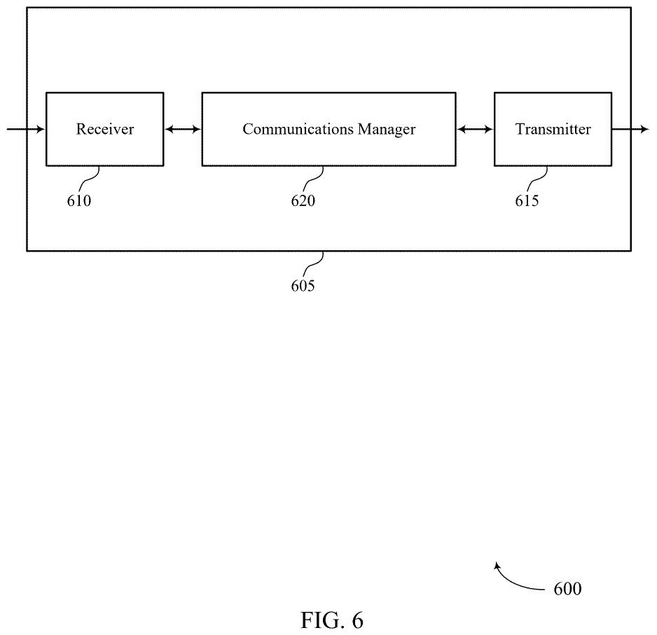

FIG. 6 shows a block diagram 600 of a device 605 that supports resource pools for control information and data for self-scheduled uplink transmissions in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to resource pools for control information and data for self-scheduled uplink transmissions). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to resource pools for control information and data for self-scheduled uplink transmissions). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of resource pools for control information and data for self-scheduled uplink transmissions as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving control signaling that indicates a first uplink resource pool and a second uplink resource pool, where the first uplink resource pool is associated with UCI for UE self-scheduled shared channel communications, and where the second uplink resource pool is associated with the UE self-scheduled shared channel communications. The communications manager 620 is capable of, configured to, or operable to support a means for transmitting an UCI message via a first uplink resource of the first uplink resource pool, where the UCI message includes scheduling information for an uplink shared channel communication in a second uplink resource of the second uplink resource pool. The communications manager 620 is capable of, configured to, or operable to support a means for transmitting the uplink shared channel communication via the second uplink resource in accordance with the scheduling information.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, and more efficient utilization of communication resources.

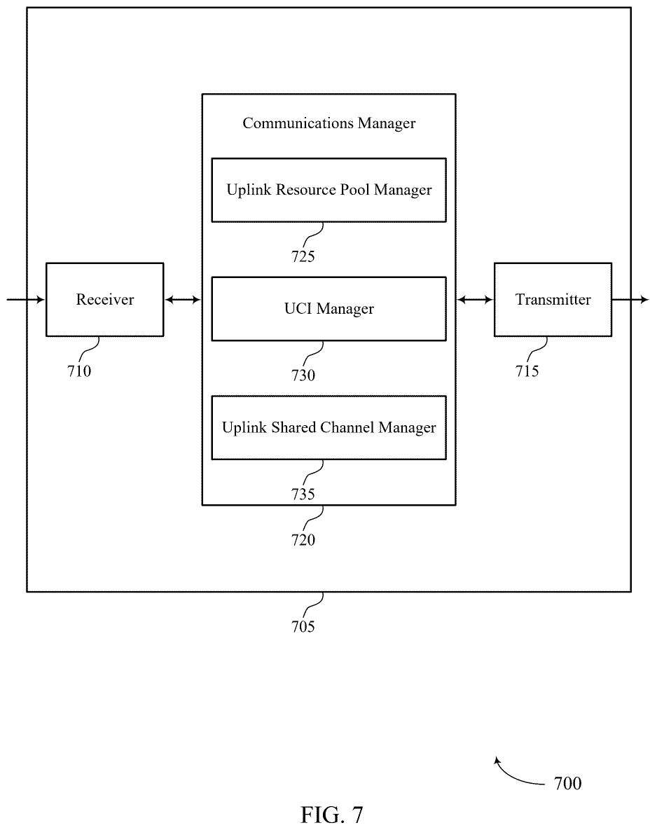

FIG. 7 shows a block diagram 700 of a device 705 that supports resource pools for control information and data for self-scheduled uplink transmissions in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to resource pools for control information and data for self-scheduled uplink transmissions). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to resource pools for control information and data for self-scheduled uplink transmissions). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of resource pools for control information and data for self-scheduled uplink transmissions as described herein. For example, the communications manager 720 may include an uplink resource pool manager 725, a UCI manager 730, an uplink shared channel manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The uplink resource pool manager 725 is capable of, configured to, or operable to support a means for receiving control signaling that indicates a first uplink resource pool and a second uplink resource pool, where the first uplink resource pool is associated with UCI for UE self-scheduled shared channel communications, and where the second uplink resource pool is associated with the UE self-scheduled shared channel communications. The UCI manager 730 is capable of, configured to, or operable to support a means for transmitting an UCI message via a first uplink resource of the first uplink resource pool, where the UCI message includes scheduling information for an uplink shared channel communication in a second uplink resource of the second uplink resource pool. The uplink shared channel manager 735 is capable of, configured to, or operable to support a means for transmitting the uplink shared channel communication via the second uplink resource in accordance with the scheduling information.

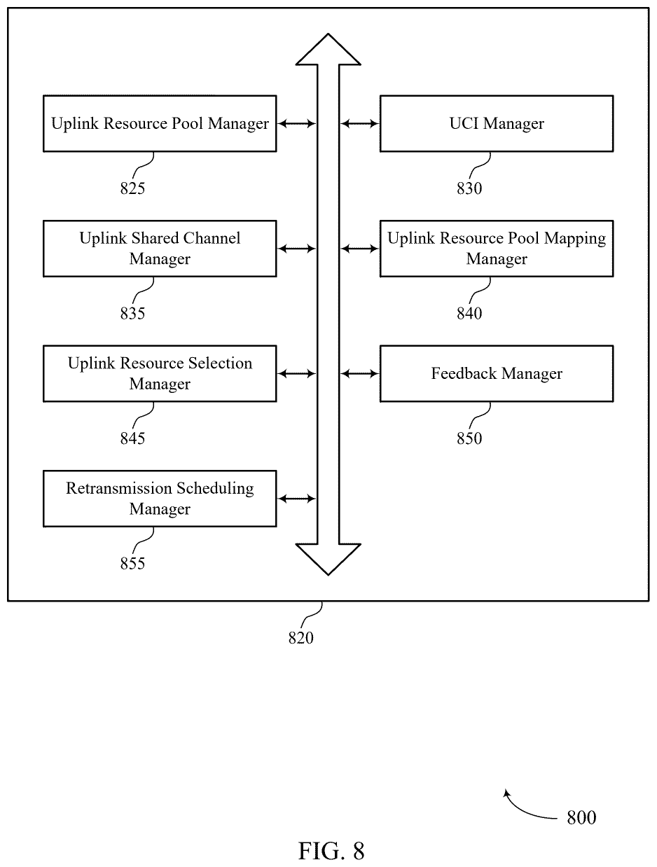

FIG. 8 shows a block diagram 800 of a communications manager 820 that supports resource pools for control information and data for self-scheduled uplink transmissions in accordance with one or more aspects of the present disclosure. The communications manager 820 may be an example of aspects of a communications manager 620, a communications manager 720, or both, as described herein. The communications manager 820, or various components thereof, may be an example of means for performing various aspects of resource pools for control information and data for self-scheduled uplink transmissions as described herein. For example, the communications manager 820 may include an uplink resource pool manager 825, a UCI manager 830, an uplink shared channel manager 835, an uplink resource pool mapping manager 840, an uplink resource selection manager 845, a feedback manager 850, a retransmission scheduling manager 855, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The uplink resource pool manager 825 is capable of, configured to, or operable to support a means for receiving control signaling that indicates a first uplink resource pool and a second uplink resource pool, where the first uplink resource pool is associated with UCI for UE self-scheduled shared channel communications, and where the second uplink resource pool is associated with the UE self-scheduled shared channel communications. The UCI manager 830 is capable of, configured to, or operable to support a means for transmitting an UCI message via a first uplink resource of the first uplink resource pool, where the UCI message includes scheduling information for an uplink shared channel communication in a second uplink resource of the second uplink resource pool. The uplink shared channel manager 835 is capable of, configured to, or operable to support a means for transmitting the uplink shared channel communication via the second uplink resource in accordance with the scheduling information.

In some examples, to support receiving the control signaling, the uplink resource pool mapping manager 840 is capable of, configured to, or operable to support a means for receiving an indication of a one-to-one mapping between first uplink resources of the first uplink resource pool and second uplink resources of the second uplink resource pool, where the first uplink resource is one-to-one mapped to the second uplink resource pool in accordance with the one-to-one mapping, and where the scheduling information indicates the second uplink resource based on the one-to-one mapping.

In some examples, the uplink resource selection manager 845 is capable of, configured to, or operable to support a means for randomly selecting the first uplink resource from the first uplink resource pool. In some examples, the uplink resource selection manager 845 is capable of, configured to, or operable to support a means for selecting the second uplink resource from the second uplink resource pool based on the first uplink resource.

In some examples, to support receiving the control signaling, the uplink resource pool mapping manager 840 is capable of, configured to, or operable to support a means for receiving an indication of a mapping between each second uplink resource of the second uplink resource pool and a set of multiple first uplink resources of the first uplink resource pool, where the first uplink resource is mapped to the second uplink resource pool in accordance with the mapping, and where the scheduling information indicates the second uplink resource based on the mapping.

In some examples, the scheduling information includes a field indicative of the second uplink resource.

In some examples, to support receiving the control signaling, the uplink resource pool mapping manager 840 is capable of, configured to, or operable to support a means for receiving an indication of a mapping between first uplink resources of the first uplink resource pool and respective sets of second uplink resources of the second uplink resource pool, where the second uplink resource pool is within a respective set of second uplink resources mapped to the first uplink resource in accordance with the mapping.

In some examples, the uplink resource selection manager 845 is capable of, configured to, or operable to support a means for randomly selecting the first uplink resource from the first uplink resource pool. In some examples, the uplink resource selection manager 845 is capable of, configured to, or operable to support a means for randomly selecting the second uplink resource from the second uplink resource pool.

In some examples, the feedback manager 850 is capable of, configured to, or operable to support a means for receiving a DCI message with a CRC scrambled by an ID associated with the UE, where the DCI message includes a feedback message for the uplink shared channel communication.

In some examples, the feedback manager 850 is capable of, configured to, or operable to support a means for receiving a group-common DCI message, where a payload of the group-common DCI message includes an ID associated with the UE and a feedback message for the uplink shared channel communication.

In some examples, the feedback manager 850 is capable of, configured to, or operable to support a means for receiving a group-common DCI message, where a payload of the group-common DCI message includes a feedback bitmap associated with second uplink resources of the second uplink resource pool, where the control signaling indicates a mapping between the second uplink resource and respective one or more bits of the feedback bitmap.

In some examples, the retransmission scheduling manager 855 is capable of, configured to, or operable to support a means for receiving, after transmission of the uplink shared channel communication, an uplink grant for a retransmission of the uplink shared channel communication. In some examples, the uplink shared channel manager 835 is capable of, configured to, or operable to support a means for transmitting the retransmission of the uplink shared channel communication in accordance with the uplink grant.

In some examples, the UCI manager 830 is capable of, configured to, or operable to support a means for transmitting, based on an absence of a feedback message for the uplink shared channel communication within a time period after transmission of the uplink shared channel communication, a second UCI message via a third uplink resource of the first uplink resource pool, where the second UCI message includes second scheduling information for a retransmission of the uplink shared channel communication in a fourth uplink resource of the second uplink resource pool. In some examples, the uplink shared channel manager 835 is capable of, configured to, or operable to support a means for transmitting the retransmission of the uplink shared channel communication via the fourth uplink resource in accordance with the second scheduling information.

In some examples, the UCI message indicates a MCS associated with the uplink shared channel communication, a payload size associated with the uplink shared channel communication, an ID associated with the UE, or any combination thereof.

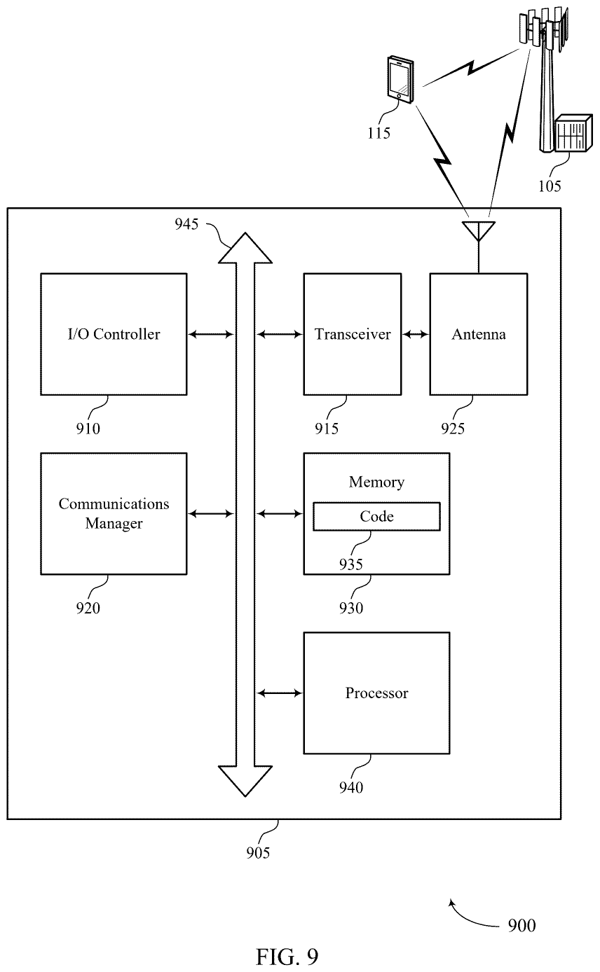

FIG. 9 shows a diagram of a system 900 including a device 905 that supports resource pools for control information and data for self-scheduled uplink transmissions in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting resource pools for control information and data for self-scheduled uplink transmissions). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving control signaling that indicates a first uplink resource pool and a second uplink resource pool, where the first uplink resource pool is associated with UCI for UE self-scheduled shared channel communications, and where the second uplink resource pool is associated with the UE self-scheduled shared channel communications. The communications manager 920 is capable of, configured to, or operable to support a means for transmitting an UCI message via a first uplink resource of the first uplink resource pool, where the UCI message includes scheduling information for an uplink shared channel communication in a second uplink resource of the second uplink resource pool. The communications manager 920 is capable of, configured to, or operable to support a means for transmitting the uplink shared channel communication via the second uplink resource in accordance with the scheduling information.

By including or configuring the communications manager 920 in accordance with examples as described herein, the device 905 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described herein with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of as described herein, or the at least one processor 940 and the at least one memory 930 may be otherwise configured to, individually or collectively, perform or support such operations.

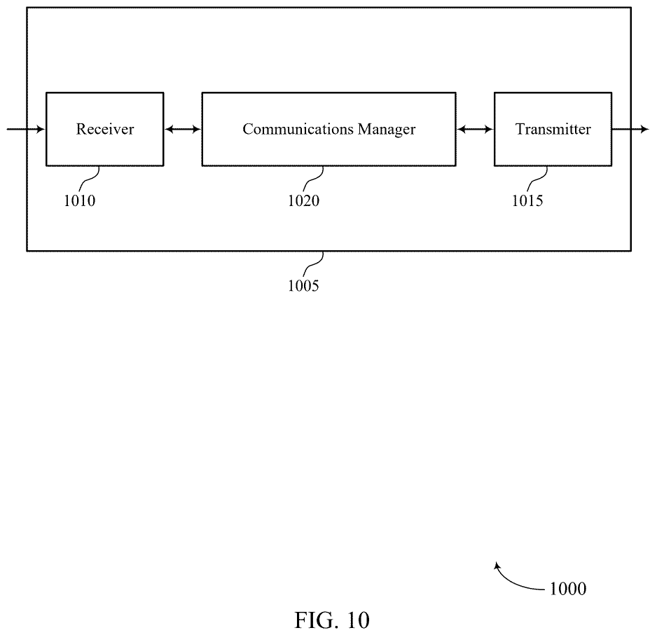

FIG. 10 shows a block diagram 1000 of a device 1005 that supports resource pools for control information and data for self-scheduled uplink transmissions in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of resource pools for control information and data for self-scheduled uplink transmissions as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for outputting control signaling that indicates a first uplink resource pool and a second uplink resource pool, where the first uplink resource pool is associated with UCI for UE self-scheduled shared channel communications, and where the second uplink resource pool is associated with the UE self-scheduled shared channel communications. The communications manager 1020 is capable of, configured to, or operable to support a means for obtaining, in association with a UE, an UCI message via a first uplink resource of the first uplink resource pool, where the UCI message includes scheduling information for an uplink shared channel communication in a second uplink resource of the second uplink resource pool. The communications manager 1020 is capable of, configured to, or operable to support a means for obtaining, in association with the UE, the uplink shared channel communication via the second uplink resource in accordance with the scheduling information.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing, reduced power consumption, and more efficient utilization of communication resources.

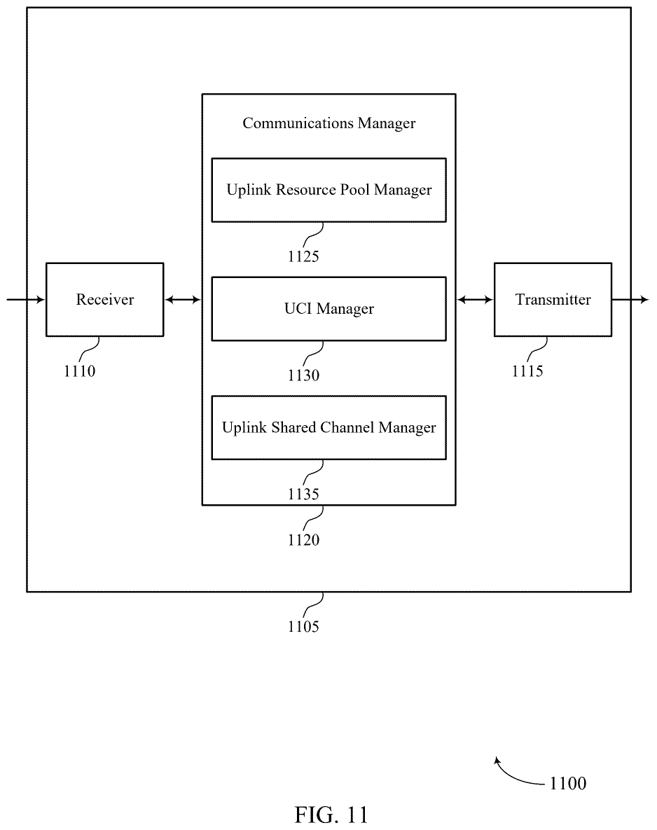

FIG. 11 shows a block diagram 1100 of a device 1105 that supports resource pools for control information and data for self-scheduled uplink transmissions in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of resource pools for control information and data for self-scheduled uplink transmissions as described herein. For example, the communications manager 1120 may include an uplink resource pool manager 1125, a UCI manager 1130, an uplink shared channel manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The uplink resource pool manager 1125 is capable of, configured to, or operable to support a means for outputting control signaling that indicates a first uplink resource pool and a second uplink resource pool, where the first uplink resource pool is associated with UCI for UE self-scheduled shared channel communications, and where the second uplink resource pool is associated with the UE self-scheduled shared channel communications. The UCI manager 1130 is capable of, configured to, or operable to support a means for obtaining, in association with a UE, an UCI message via a first uplink resource of the first uplink resource pool, where the UCI message includes scheduling information for an uplink shared channel communication in a second uplink resource of the second uplink resource pool. The uplink shared channel manager 1135 is capable of, configured to, or operable to support a means for obtaining, in association with the UE, the uplink shared channel communication via the second uplink resource in accordance with the scheduling information.

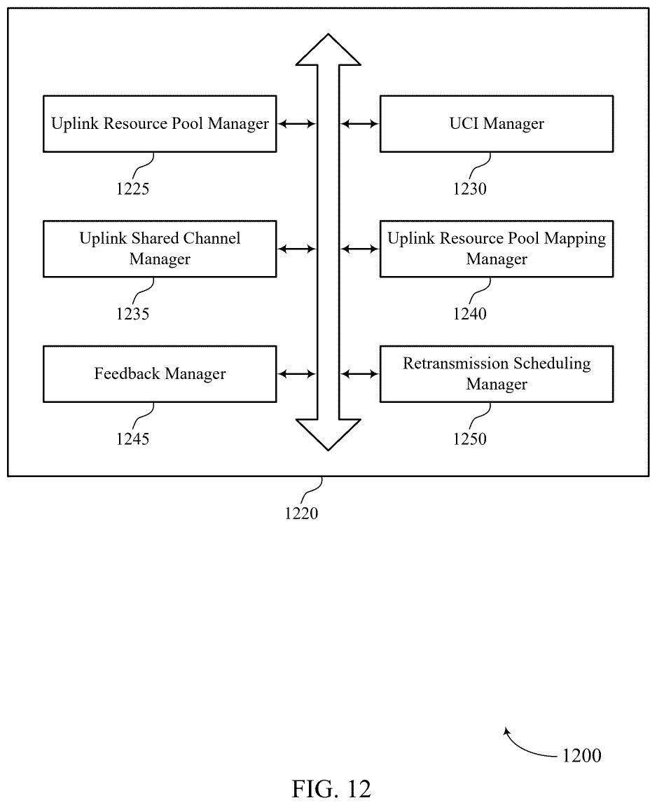

FIG. 12 shows a block diagram 1200 of a communications manager 1220 that supports resource pools for control information and data for self-scheduled uplink transmissions in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of resource pools for control information and data for self-scheduled uplink transmissions as described herein. For example, the communications manager 1220 may include an uplink resource pool manager 1225, a UCI manager 1230, an uplink shared channel manager 1235, an uplink resource pool mapping manager 1240, a feedback manager 1245, a retransmission scheduling manager 1250, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The uplink resource pool manager 1225 is capable of, configured to, or operable to support a means for outputting control signaling that indicates a first uplink resource pool and a second uplink resource pool, where the first uplink resource pool is associated with UCI for UE self-scheduled shared channel communications, and where the second uplink resource pool is associated with the UE self-scheduled shared channel communications. The UCI manager 1230 is capable of, configured to, or operable to support a means for obtaining, in association with a UE, an UCI message via a first uplink resource of the first uplink resource pool, where the UCI message includes scheduling information for an uplink shared channel communication in a second uplink resource of the second uplink resource pool. The uplink shared channel manager 1235 is capable of, configured to, or operable to support a means for obtaining, in association with the UE, the uplink shared channel communication via the second uplink resource in accordance with the scheduling information.

In some examples, to support outputting the control signaling, the uplink resource pool mapping manager 1240 is capable of, configured to, or operable to support a means for outputting an indication of a one-to-one mapping between first uplink resources of the first uplink resource pool and second uplink resources of the second uplink resource pool, where the first uplink resource is one-to-one mapped to the second uplink resource pool in accordance with the one-to-one mapping, and where the scheduling information indicates the second uplink resource based on the one-to-one mapping.

In some examples, to support outputting the control signaling, the uplink resource pool mapping manager 1240 is capable of, configured to, or operable to support a means for outputting an indication of a mapping between each second uplink resource of the second uplink resource pool and a set of multiple first uplink resources of the first uplink resource pool, where the first uplink resource is mapped to the second uplink resource pool in accordance with the mapping, and where the scheduling information indicates the second uplink resource based on the mapping.

In some examples, the scheduling information includes a field indicative of the second uplink resource.

In some examples, to support outputting the control signaling, the uplink resource pool mapping manager 1240 is capable of, configured to, or operable to support a means for outputting an indication of a mapping between first uplink resources of the first uplink resource pool and respective sets of second uplink resources of the second uplink resource pool, where the second uplink resource pool is within a respective set of second uplink resources mapped to the first uplink resource in accordance with the mapping.

In some examples, the feedback manager 1245 is capable of, configured to, or operable to support a means for outputting a DCI message with a CRC scrambled by an ID associated with the UE, where the DCI message includes a feedback message for the uplink shared channel communication.

In some examples, the feedback manager 1245 is capable of, configured to, or operable to support a means for outputting a group-common DCI message, where a payload of the group-common DCI message includes an ID associated with the UE and a feedback message for the uplink shared channel communication.

In some examples, the feedback manager 1245 is capable of, configured to, or operable to support a means for outputting a group-common DCI message, where a payload of the group-common DCI message includes a feedback bitmap associated with second uplink resources of the second uplink resource pool, where the control signaling indicates a mapping between the second uplink resource and respective one or more bits of the feedback bitmap.

In some examples, the retransmission scheduling manager 1250 is capable of, configured to, or operable to support a means for outputting, after obtention of the uplink shared channel communication, an uplink grant for a retransmission of the uplink shared channel communication. In some examples, the uplink shared channel manager 1235 is capable of, configured to, or operable to support a means for obtaining the retransmission of the uplink shared channel communication in accordance with the uplink grant.

In some examples, outputting the uplink grant is based on successfully decoding the UCI message and failing to successfully decode the uplink shared channel communication.

In some examples, the UCI manager 1230 is capable of, configured to, or operable to support a means for obtaining, in association with an absence of a feedback message for the uplink shared channel communication within a time period after transmission of the uplink shared channel communication, a second UCI message via a third uplink resource of the first uplink resource pool, where the second UCI message includes second scheduling information for a retransmission of the uplink shared channel communication in a fourth uplink resource of the second uplink resource pool. In some examples, the uplink shared channel manager 1235 is capable of, configured to, or operable to support a means for obtaining the retransmission of the uplink shared channel communication via the fourth uplink resource in accordance with the second scheduling information.

In some examples, the UCI message indicates a MCS associated with the uplink shared channel communication, a payload size associated with the uplink shared channel communication, an ID associated with the UE, or any combination thereof.

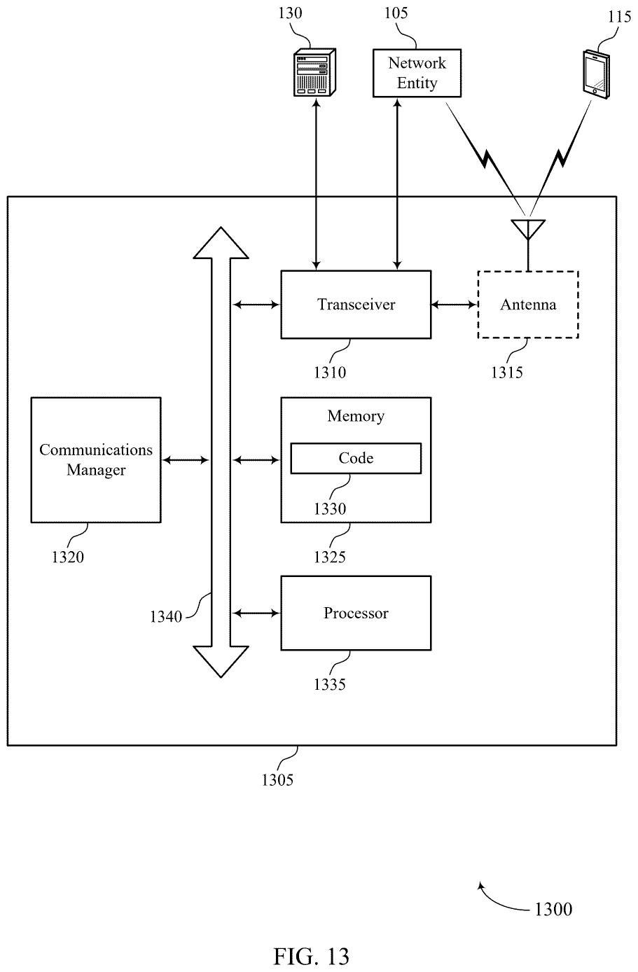

FIG. 13 shows a diagram of a system 1300 including a device 1305 that supports resource pools for control information and data for self-scheduled uplink transmissions in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting resource pools for control information and data for self-scheduled uplink transmissions). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for outputting control signaling that indicates a first uplink resource pool and a second uplink resource pool, where the first uplink resource pool is associated with UCI for UE self-scheduled shared channel communications, and where the second uplink resource pool is associated with the UE self-scheduled shared channel communications. The communications manager 1320 is capable of, configured to, or operable to support a means for obtaining, in association with a UE, an UCI message via a first uplink resource of the first uplink resource pool, where the UCI message includes scheduling information for an uplink shared channel communication in a second uplink resource of the second uplink resource pool. The communications manager 1320 is capable of, configured to, or operable to support a means for obtaining, in association with the UE, the uplink shared channel communication via the second uplink resource in accordance with the scheduling information.

By including or configuring the communications manager 1320 in accordance with examples as described herein, the device 1305 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described herein with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of resource pools for control information and data for self-scheduled uplink transmissions as described herein, or the at least one processor 1335 and the at least one memory 1325 may be otherwise configured to, individually or collectively, perform or support such operations.

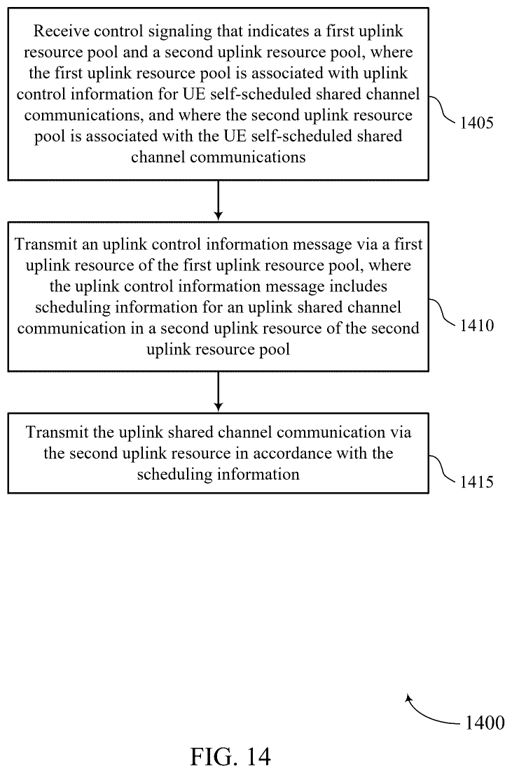

FIG. 14 shows a flowchart illustrating a method 1400 that supports resource pools for control information and data for self-scheduled uplink transmissions in accordance with one or more aspects of the present disclosure. The operations of the method 1400 may be implemented by a UE or its components as described herein. For example, the operations of the method 1400 may be performed by a UE 115 as described herein with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving control signaling that indicates a first uplink resource pool and a second uplink resource pool, where the first uplink resource pool is associated with UCI for UE self-scheduled shared channel communications, and where the second uplink resource pool is associated with the UE self-scheduled shared channel communications. The operations of 1405 may be performed in accordance with examples as disclosed herein. In some examples, aspects of the operations of 1405 may be performed by an uplink resource pool manager 825 as described herein with reference to FIG. 8.

At 1410, the method may include transmitting an UCI message via a first uplink resource of the first uplink resource pool, where the UCI message includes scheduling information for an uplink shared channel communication in a second uplink resource of the second uplink resource pool. The operations of 1410 may be performed in accordance with examples as disclosed herein. In some examples, aspects of the operations of 1410 may be performed by a UCI manager 830 as described herein with reference to FIG. 8.

At 1415, the method may include transmitting the uplink shared channel communication via the second uplink resource in accordance with the scheduling information. The operations of 1415 may be performed in accordance with examples as disclosed herein. In some examples, aspects of the operations of 1415 may be performed by an uplink shared channel manager 835 as described herein with reference to FIG. 8.

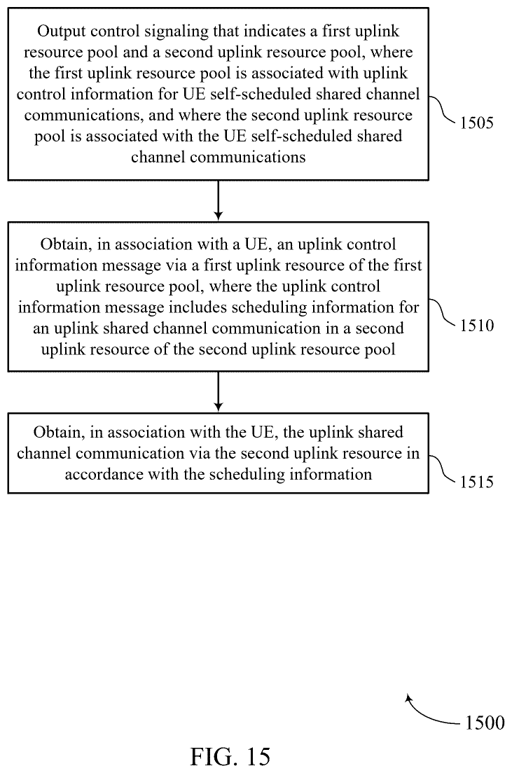

FIG. 15 shows a flowchart illustrating a method 1500 that supports resource pools for control information and data for self-scheduled uplink transmissions in accordance with one or more aspects of the present disclosure. The operations of the method 1500 may be implemented by a network entity or its components as described herein. For example, the operations of the method 1500 may be performed by a network entity as described herein with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include outputting control signaling that indicates a first uplink resource pool and a second uplink resource pool, where the first uplink resource pool is associated with UCI for UE self-scheduled shared channel communications, and where the second uplink resource pool is associated with the UE self-scheduled shared channel communications. The operations of 1505 may be performed in accordance with examples as disclosed herein. In some examples, aspects of the operations of 1505 may be performed by an uplink resource pool manager 1225 as described herein with reference to FIG. 12.

At 1510, the method may include obtaining, in association with a UE, an UCI message via a first uplink resource of the first uplink resource pool, where the UCI message includes scheduling information for an uplink shared channel communication in a second uplink resource of the second uplink resource pool. The operations of 1510 may be performed in accordance with examples as disclosed herein. In some examples, aspects of the operations of 1510 may be performed by a UCI manager 1230 as described herein with reference to FIG. 12.

At 1515, the method may include obtaining, in association with the UE, the uplink shared channel communication via the second uplink resource in accordance with the scheduling information. The operations of 1515 may be performed in accordance with examples as disclosed herein. In some examples, aspects of the operations of 1515 may be performed by an uplink shared channel manager 1235 as described herein with reference to FIG. 12.

The following provides an overview of aspects of the present disclosure:

Aspect 1: A method for wireless communications at a UE, comprising: receiving control signaling that indicates a first uplink resource pool and a second uplink resource pool, wherein the first uplink resource pool is associated with UCI for UE self-scheduled shared channel communications, and wherein the second uplink resource pool is associated with the UE self-scheduled shared channel communications; transmitting an UCI message via a first uplink resource of the first uplink resource pool, wherein the UCI message includes scheduling information for an uplink shared channel communication in a second uplink resource of the second uplink resource pool; and transmitting the uplink shared channel communication via the second uplink resource in accordance with the scheduling information.

Aspect 2: The method of aspect 1, wherein receiving the control signaling comprises: receiving an indication of a one-to-one mapping between first uplink resources of the first uplink resource pool and second uplink resources of the second uplink resource pool, wherein the first uplink resource is one-to-one mapped to the second uplink resource pool in accordance with the one-to-one mapping, and wherein the scheduling information indicates the second uplink resource based at least in part on the one-to-one mapping.

Aspect 3: The method of any of aspects 1 through 2, further comprising: randomly selecting the first uplink resource from the first uplink resource pool; and selecting the second uplink resource from the second uplink resource pool based at least in part on the first uplink resource.

Aspect 4: The method of aspect 1, wherein receiving the control signaling comprises: receiving an indication of a mapping between each second uplink resource of the second uplink resource pool and a plurality of first uplink resources of the first uplink resource pool, wherein the first uplink resource is mapped to the second uplink resource pool in accordance with the mapping, and wherein the scheduling information indicates the second uplink resource based at least in part on the mapping.

Aspect 5: The method of any of aspects 1 through 4, wherein the scheduling information comprises a field indicative of the second uplink resource.

Aspect 6: The method of aspect 5, wherein receiving the control signaling comprises: receiving an indication of a mapping between first uplink resources of the first uplink resource pool and respective sets of second uplink resources of the second uplink resource pool, wherein the second uplink resource pool is within a respective set of second uplink resources mapped to the first uplink resource in accordance with the mapping.

Aspect 7: The method of any of aspects 5 through 6, further comprising: randomly selecting the first uplink resource from the first uplink resource pool; and randomly selecting the second uplink resource from the second uplink resource pool.

Aspect 8: The method of any of aspects 1 through 7, further comprising: receiving a DCI message with a CRC scrambled by an identifier associated with the UE, wherein the DCI message includes a feedback message for the uplink shared channel communication.

Aspect 9: The method of any of aspects 1 through 7, further comprising: receiving a group-common DCI message, wherein a payload of the group-common DCI message includes an identifier associated with the UE and a feedback message for the uplink shared channel communication.

Aspect 10: The method of any of aspects 1 through 7, further comprising: receiving a group-common DCI message, wherein a payload of the group-common DCI message comprises a feedback bitmap associated with second uplink resources of the second uplink resource pool, wherein the control signaling indicates a mapping between the second uplink resource and respective one or more bits of the feedback bitmap.

Aspect 11: The method of any of aspects 1 through 10, further comprising: receiving, after transmission of the uplink shared channel communication, an uplink grant for a retransmission of the uplink shared channel communication; and transmitting the retransmission of the uplink shared channel communication in accordance with the uplink grant.

Aspect 12: The method of any of aspects The method of any of aspects 1through 7, further comprising: transmitting, based at least in part on an absence of a feedback message for the uplink shared channel communication within a time period after transmission of the uplink shared channel communication, a second UCI message via a third uplink resource of the first uplink resource pool, wherein the second UCI message includes second scheduling information for a retransmission of the uplink shared channel communication in a fourth uplink resource of the second uplink resource pool; and transmitting the retransmission of the uplink shared channel communication via the fourth uplink resource in accordance with the second scheduling information.

Aspect 13: The method of any of aspects 1 through 12, wherein the UCI message indicates an MCS associated with the uplink shared channel communication, a payload size associated with the uplink shared channel communication, an identifier associated with the UE, or any combination thereof.

Aspect 14: A method for wireless communications at a network entity, comprising: outputting control signaling that indicates a first uplink resource pool and a second uplink resource pool, wherein the first uplink resource pool is associated with UCI for UE self-scheduled shared channel communications, and wherein the second uplink resource pool is associated with the UE self-scheduled shared channel communications; obtaining, in association with a UE, an UCI message via a first uplink resource of the first uplink resource pool, wherein the UCI message includes scheduling information for an uplink shared channel communication in a second uplink resource of the second uplink resource pool; and obtaining, in association with the UE, the uplink shared channel communication via the second uplink resource in accordance with the scheduling information.

Aspect 15: The method of aspect 14, wherein outputting the control signaling comprises: outputting an indication of a one-to-one mapping between first uplink resources of the first uplink resource pool and second uplink resources of the second uplink resource pool, wherein the first uplink resource is one-to-one mapped to the second uplink resource pool in accordance with the one-to-one mapping, and wherein the scheduling information indicates the second uplink resource based at least in part on the one-to-one mapping.

Aspect 16: The method of any of aspects 14 through 15, wherein outputting the control signaling comprises: outputting an indication of a mapping between each second uplink resource of the second uplink resource pool and a plurality of first uplink resources of the first uplink resource pool, wherein the first uplink resource is mapped to the second uplink resource pool in accordance with the mapping, and wherein the scheduling information indicates the second uplink resource based at least in part on the mapping.

Aspect 17: The method of aspect 14, wherein the scheduling information comprises a field indicative of the second uplink resource.

Aspect 18: The method of aspect 17, wherein outputting the control signaling comprises: outputting an indication of a mapping between first uplink resources of the first uplink resource pool and respective sets of second uplink resources of the second uplink resource pool, wherein the second uplink resource pool is within a respective set of second uplink resources mapped to the first uplink resource in accordance with the mapping.

Aspect 19: The method of any of aspects 14 through 18, further comprising: outputting a DCI message with a CRC scrambled by an identifier associated with the UE, wherein the DCI message includes a feedback message for the uplink shared channel communication.

Aspect 20: The method of any of aspects 14 through 18, further comprising: outputting a group-common DCI message, wherein a payload of the group-common DCI message includes an identifier associated with the UE and a feedback message for the uplink shared channel communication.

Aspect 21: The method of any of aspects 14 through 18, further comprising: outputting a group-common DCI message, wherein a payload of the group-common DCI message comprises a feedback bitmap associated with second uplink resources of the second uplink resource pool, wherein the control signaling indicates a mapping between the second uplink resource and respective one or more bits of the feedback bitmap.

Aspect 22: The method of any of aspects 14 through 18, further comprising: outputting, after obtention of the uplink shared channel communication, an uplink grant for a retransmission of the uplink shared channel communication ; and obtaining the retransmission of the uplink shared channel communication in accordance with the uplink grant.

Aspect 23: The method of aspect 22, wherein outputting the uplink grant is based at least in part on successfully decoding the UCI message and failing to successfully decode the uplink shared channel communication.

Aspect 24: The method of any of aspects 14 through 18, further comprising: obtaining, in association with an absence of a feedback message for the uplink shared channel communication within a time period after transmission of the uplink shared channel communication, a second UCI message via a third uplink resource of the first uplink resource pool, wherein the second UCI message includes second scheduling information for a retransmission of the uplink shared channel communication in a fourth uplink resource of the second uplink resource pool; and obtaining the retransmission of the uplink shared channel communication via the fourth uplink resource in accordance with the second scheduling information.

Aspect 25: The method of any of aspects 14 through 24, wherein the UCI message indicates an MCS associated with the uplink shared channel communication, a payload size associated with the uplink shared channel communication, an identifier associated with the UE, or any combination thereof.

Aspect 26: A UE for wireless communications, comprising at least one processor; and at least one memory coupled with the at least one processor, with instructions stored in the at least one memory, the instructions being executable by the at least one processor, individually or in any combination, to cause the UE to perform a method of any of aspects 1 through 13.

Aspect 27: A UE for wireless communications, comprising at least one means for performing a method of any of aspects 1 through 13.

Aspect 28: A non-transitory computer-readable medium storing code for wireless communications, the code comprising instructions executable by one or more processors to perform a method of any of aspects 1 through 13.

Aspect 29: A network entity for wireless communications, comprising at least one processor; and at least one memory coupled with the at least one processor, with instructions stored in the at least one memory, the instructions being executable by the at least one processor, individually or in any combination, to cause the network entity to perform a method of any of aspects 14 through 25.

Aspect 30: A network entity for wireless communications, comprising at least one means for performing a method of any of aspects 14 through 25.

Aspect 31: A non-transitory computer-readable medium storing code for wireless communications, the code comprising instructions executable by one or more processors to perform a method of any of aspects 14 through 25.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
at least one processor; and
at least one memory coupled with the at least one processor, with instructions stored in the at least one memory, the instructions being executable by the at least one processor, individually or in any combination, to cause the UE to:
receive control signaling that indicates a first uplink resource pool and a second uplink resource pool, wherein the first uplink resource pool is associated with uplink control information for UE self-scheduled shared channel communications, and wherein the second uplink resource pool is associated with the UE self-scheduled shared channel communications;
transmit an uplink control information message via a first uplink resource of the first uplink resource pool, wherein the uplink control information message includes scheduling information for an uplink shared channel communication in a second uplink resource of the second uplink resource pool; and
transmit the uplink shared channel communication via the second uplink resource in accordance with the scheduling information.

2. The UE of claim 1, wherein, to receive the control signaling, the instructions are executable by the at least one processor, individually or in any combination, to cause the UE to:
receive an indication of a one-to-one mapping between first uplink resources of the first uplink resource pool and second uplink resources of the second uplink resource pool, wherein the first uplink resource is one-to-one mapped to the second uplink resource pool in accordance with the one-to-one mapping, and wherein the scheduling information indicates the second uplink resource based at least in part on the one-to-one mapping.

3. The UE of claim 1, wherein the instructions are executable by the at least one processor, individually or in any combination, to cause the UE to:
randomly select the first uplink resource from the first uplink resource pool; and
select the second uplink resource from the second uplink resource pool based at least in part on the first uplink resource.

4. The UE of claim 1, wherein, to receive the control signaling, the instructions are executable by the at least one processor, individually or in any combination, to cause the UE to:
receive an indication of a mapping between each second uplink resource of the second uplink resource pool and a plurality of first uplink resources of the first uplink resource pool, wherein the first uplink resource is mapped to the second uplink resource pool in accordance with the mapping, and wherein the scheduling information indicates the second uplink resource based at least in part on the mapping.

5. The UE of claim 1, wherein the scheduling information comprises a field indicative of the second uplink resource.

6. The UE of claim 5, wherein, to receive the control signaling, the instructions are executable by the at least one processor, individually or in any combination, to cause the UE to:
receive an indication of a mapping between first uplink resources of the first uplink resource pool and respective sets of second uplink resources of the second uplink resource pool, wherein the second uplink resource pool is within a respective set of second uplink resources mapped to the first uplink resource in accordance with the mapping.

7. The UE of claim 5, wherein the instructions are executable by the at least one processor, individually or in any combination, to cause the UE to:
randomly select the first uplink resource from the first uplink resource pool; and
randomly select the second uplink resource from the second uplink resource pool.

8. The UE of claim 1, wherein the instructions are executable by the at least one processor, individually or in any combination, to cause the UE to:
receive a downlink control information message with a cyclic redundancy check scrambled by an identifier associated with the UE, wherein the downlink control information message includes a feedback message for the uplink shared channel communication.

9. The UE of claim 1, wherein the instructions are executable by the at least one processor, individually or in any combination, to cause the UE to:
receive a group-common downlink control information message, wherein a payload of the group-common downlink control information message includes an identifier associated with the UE and a feedback message for the uplink shared channel communication.

10. The UE of claim 1, wherein the instructions are executable by the at least one processor, individually or in any combination, to cause the UE to:
receive a group-common downlink control information message, wherein a payload of the group-common downlink control information message comprises a feedback bitmap associated with second uplink resources of the second uplink resource pool, wherein the control signaling indicates a mapping between the second uplink resource and respective one or more bits of the feedback bitmap.

11. The UE of claim 1, wherein the instructions are executable by the at least one processor, individually or in any combination, to cause the UE to:
receive, after transmission of the uplink shared channel communication, an uplink grant for a retransmission of the uplink shared channel communication; and
transmit the retransmission of the uplink shared channel communication in accordance with the uplink grant.

12. The UE of claim 1, wherein the instructions are executable by the at least one processor, individually or in any combination, to cause the UE to:
transmit, based at least in part on an absence of a feedback message for the uplink shared channel communication within a time period after transmission of the uplink shared channel communication, a second uplink control information message via a third uplink resource of the first uplink resource pool, wherein the second uplink control information message includes second scheduling information for a retransmission of the uplink shared channel communication in a fourth uplink resource of the second uplink resource pool; and
transmit the retransmission of the uplink shared channel communication via the fourth uplink resource in accordance with the second scheduling information.

13. The UE of claim 1, wherein the uplink control information message indicates a modulation and coding scheme associated with the uplink shared channel communication, a payload size associated with the uplink shared channel communication, an identifier associated with the UE, or any combination thereof.

14. A network entity, comprising:
at least one processor; and
at least one memory coupled with the at least one processor, with instructions stored in the at least one memory, the instructions being executable by the at least one processor, individually or in any combination, to cause the network entity to:
output control signaling that indicates a first uplink resource pool and a second uplink resource pool, wherein the first uplink resource pool is associated with uplink control information for user equipment (UE) self-scheduled shared channel communications, and wherein the second uplink resource pool is associated with the UE self-scheduled shared channel communications;
obtain, in association with a UE, an uplink control information message via a first uplink resource of the first uplink resource pool, wherein the uplink control information message includes scheduling information for an uplink shared channel communication in a second uplink resource of the second uplink resource pool; and
obtain, in association with the UE, the uplink shared channel communication via the second uplink resource in accordance with the scheduling information.

15. The network entity of claim 14, wherein, to output the control signaling, the instructions are executable by the at least one processor, individually or in any combination, to cause the network entity to:
output an indication of a one-to-one mapping between first uplink resources of the first uplink resource pool and second uplink resources of the second uplink resource pool, wherein the first uplink resource is one-to-one mapped to the second uplink resource pool in accordance with the one-to-one mapping, and wherein the scheduling information indicates the second uplink resource based at least in part on the one-to-one mapping.

16. The network entity of claim 14, wherein, to output the control signaling, the instructions are executable by the at least one processor, individually or in any combination, to cause the network entity to:
output an indication of a mapping between each second uplink resource of the second uplink resource pool and a plurality of first uplink resources of the first uplink resource pool, wherein the first uplink resource is mapped to the second uplink resource pool in accordance with the mapping, and wherein the scheduling information indicates the second uplink resource based at least in part on the mapping.

17. The network entity of claim 14, wherein the scheduling information comprises a field indicative of the second uplink resource.

18. The network entity of claim 17, wherein, to output the control signaling, the instructions are executable by the at least one processor, individually or in any combination, to cause the network entity to:
output an indication of a mapping between first uplink resources of the first uplink resource pool and respective sets of second uplink resources of the second uplink resource pool, wherein the second uplink resource pool is within a respective set of second uplink resources mapped to the first uplink resource in accordance with the mapping.

19. The network entity of claim 14, wherein the instructions are executable by the at least one processor, individually or in any combination, to cause the network entity to:
output a downlink control information message with a cyclic redundancy check scrambled by an identifier associated with the UE, wherein the downlink control information message includes a feedback message for the uplink shared channel communication.

20. The network entity of claim 14, wherein the instructions are executable by the at least one processor, individually or in any combination, to cause the network entity to:
output a group-common downlink control information message, wherein a payload of the group-common downlink control information message includes an identifier associated with the UE and a feedback message for the uplink shared channel communication.

21. The network entity of claim 14, wherein the instructions are executable by the at least one processor, individually or in any combination, to cause the network entity to:
output a group-common downlink control information message, wherein a payload of the group-common downlink control information message comprises a feedback bitmap associated with second uplink resources of the second uplink resource pool, wherein the control signaling indicates a mapping between the second uplink resource and respective one or more bits of the feedback bitmap.

22. The network entity of claim 14, wherein the instructions are executable by the at least one processor, individually or in any combination, to cause the network entity to:
output, after obtention of the uplink shared channel communication, an uplink grant for a retransmission of the uplink shared channel communication; and
obtain the retransmission of the uplink shared channel communication in accordance with the uplink grant.

23. The network entity of claim 22, wherein outputting the uplink grant is based at least in part on successfully decoding the uplink control information message and failing to successfully decode the uplink shared channel communication.

24. The network entity of claim 14, wherein the instructions are executable by the at least one processor, individually or in any combination, to cause the network entity to:
obtain, in association with an absence of a feedback message for the uplink shared channel communication within a time period after transmission of the uplink shared channel communication, a second uplink control information message via a third uplink resource of the first uplink resource pool, wherein the second uplink control information message includes second scheduling information for a retransmission of the uplink shared channel communication in a fourth uplink resource of the second uplink resource pool; and
obtain the retransmission of the uplink shared channel communication via the fourth uplink resource in accordance with the second scheduling information.

25. The network entity of claim 14, wherein the uplink control information message indicates a modulation and coding scheme associated with the uplink shared channel communication, a payload size associated with the uplink shared channel communication, an identifier associated with the UE, or any combination thereof.

26. A method for wireless communications at a user equipment (UE), comprising:
receiving control signaling that indicates a first uplink resource pool and a second uplink resource pool, wherein the first uplink resource pool is associated with uplink control information for UE self-scheduled shared channel communications, and wherein the second uplink resource pool is associated with the UE self-scheduled shared channel communications;
transmitting an uplink control information message via a first uplink resource of the first uplink resource pool, wherein the uplink control information message includes scheduling information for an uplink shared channel communication in a second uplink resource of the second uplink resource pool; and
transmitting the uplink shared channel communication via the second uplink resource in accordance with the scheduling information.

27. The method of claim 26, wherein receiving the control signaling comprises:
receiving an indication of a one-to-one mapping between first uplink resources of the first uplink resource pool and second uplink resources of the second uplink resource pool, wherein the first uplink resource is one-to-one mapped to the second uplink resource pool in accordance with the one-to-one mapping, and wherein the scheduling information indicates the second uplink resource based at least in part on the one-to-one mapping.

28. The method of claim 26, further comprising:
randomly selecting the first uplink resource from the first uplink resource pool; and
selecting the second uplink resource from the second uplink resource pool based at least in part on the first uplink resource.

29. The method of claim 26, wherein receiving the control signaling comprises:
receiving an indication of a mapping between each second uplink resource of the second uplink resource pool and a plurality of first uplink resources of the first uplink resource pool, wherein the first uplink resource is mapped to the second uplink resource pool in accordance with the mapping, and wherein the scheduling information indicates the second uplink resource based at least in part on the mapping.

30. A method for wireless communications at a network entity, comprising:
outputting control signaling that indicates a first uplink resource pool and a second uplink resource pool, wherein the first uplink resource pool is associated with uplink control information for user equipment (UE) self-scheduled shared channel communications, and wherein the second uplink resource pool is associated with the UE self-scheduled shared channel communications;
obtaining, in association with a UE, an uplink control information message via a first uplink resource of the first uplink resource pool, wherein the uplink control information message includes scheduling information for an uplink shared channel communication in a second uplink resource of the second uplink resource pool; and
obtaining, in association with the UE, the uplink shared channel communication via the second uplink resource in accordance with the scheduling information.
